(19) United States
(12) Patent Application Publication
(10) Pub. No.: US 2018/0182355 A1
(43) Pub. Date: Jun. 28, 2018

(54) DISPLAY DEVICE AND DISPLAY METHOD

(71) Applicant: Semiconductor Energy Laboratory Co., Ltd., Atsugi-shi (JP)

(72) Inventors: Hidetomo Kobayashi, Isehara (JP); Kei Takahashi, Sagamihara (JP)

(21) Appl. No.: 15/832,827

(22) Filed: Dec. 6, 2017

(30) Foreign Application Priority Data
Dec. 22, 2016 (JP) 2016-249720

(51) Int. Cl. G09G 5/10; G09G 3/36; G09G 3/20

(52) U.S. Cl. CPC G09G 5/10; G09G 3/3674; G09G 3/3648; G09G 2320/02; G09G 2300/0413; G09G 2310/08; G09G 3/2014

(57) ABSTRACT

The display evenness of a large or high-resolution display device is improved. Provided is a display device which includes a source driver, a gate driver, a first pixel, and a second pixel. The first pixel and the second pixel are electrically connected to the source driver and the gate driver. The first pixel is located closer to the source driver than the second pixel is. The gate driver has a function of supplying write signals to the first pixel and the second pixel. The pulse width of the write signal supplied to the second pixel is larger than the pulse width of the write signal supplied to the first pixel.

### BACKGROUND OF THE INVENTION

### 1. Field of the Invention

One embodiment of the present invention relates to a display device and a display method.

Note that one embodiment of the present invention is not limited to the above technical field. The technical field of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, an imaging device, a memory device, a method for driving any of them, and a method for manufacturing any of them.

### 2. Description of the Related Art

In recent years, larger display devices have been required. Examples include a television device for home use (also referred to as a TV or a television receiver), digital signage, and a public information display (PID). Larger digital signage, PID, and the like can provide an increased amount of information, and attract more attention when used for advertisement or the like, so that the effectiveness of the advertisement is expected to be increased.

In addition, display devices with a higher resolution have been required. For example, television devices (also referred as TVs or television receivers) including a large number of pixels, such as full high definition (1920×1080 pixels), 4K (e.g., 3840×2160 pixels or 4096×2160 pixels), and 8K (e.g., 7680×4320 pixels or 8192×4320 pixels) television devices, have been actively developed.

As an example of a means for achieving a display device with a larger size and a higher resolution, Patent Document 1 discloses a technique for arranging a plurality of display panels such that the display panels do not have an obvious boundary.

### REFERENCE

### [Patent Document 1] Japanese Published Patent Application No. 2015-180924

### SUMMARY OF THE INVENTION

Large or high-resolution display devices tend to have a problem such as display unevenness because their drivers do not have sufficient driving capability relative to the size of the display devices.

For example, in some cases, the increase or decrease rate of a data voltage supplied to a pixel that is located away from a source driver is lower than that of a data voltage supplied to a pixel that is located close to the source driver.

Therefore, when a method for writing data to all pixels is adjusted to the increase or decrease rate of the data voltage supplied to the pixel that is located close to the source driver, there may be insufficient time to write data to the pixel that is located away from the source driver. In other words, it may be difficult to sufficiently supply a data voltage to the pixel that is located away from the source driver. This may cause display unevenness.

When a method for writing data to all pixels is adjusted to the increase or decrease rate of the data voltage supplied to the pixel that is located away from the source driver, degradation of display frequency characteristics may result in a decrease of display quality of the display device.

In view of the above, an object of one embodiment of the present invention is to improve the display evenness of a large or high-resolution display device. Another object of one embodiment of the present invention is to improve the display quality of a large or high-resolution display device.

The objects of one embodiment of the present invention are not limited to the above objects. The objects described above do not disturb the existence of other objects. The other objects are ones that are not described above and will be described below. The other objects will be apparent from and can be derived from the description of the specification, the drawings, and the like by those skilled in the art. One embodiment of the present invention solves at least one of the above objects and the other objects.

One embodiment of the present invention is a display device which includes a source driver, a gate driver, a first pixel, and a second pixel. The first pixel and the second pixel are electrically connected to the source driver and the gate driver. The first pixel is located closer to the source driver than the second pixel is. The gate driver has a function of supplying write signals to the first pixel and the second pixel. The pulse width of the write signal supplied to the second pixel is larger than the pulse width of the write signal supplied to the first pixel.

Another embodiment of the present invention is a display device which includes a source driver, a gate driver, and first to M-th pixels (M is a natural number greater than or equal to 2) electrically connected to the source driver and the gate driver. The j-th pixel (j is a natural number greater than or equal to 2 and less than or equal to M) is located closer to the source driver than the (j+l)-th pixel (l is a natural number less than or equal to (M−j)) is. The gate driver has a function of supplying write signals to the first to M-th pixels. The pulse width of the write signal supplied to the (j+l)-th pixel is larger than the pulse width of the write signal supplied to the j-th pixel.

It is preferable that the display device of the above embodiment further include a host processor and a display controller; the host processor have a function of supplying a digital signal; the display controller have a function of receiving the digital signal; the display controller have a function of supplying a control signal for the source driver and a control signal for the gate driver; the source driver have a function of receiving the control signal for the source driver; the gate driver have a function of receiving the control signal for the gate driver; and the digital signal include a dummy signal.

In the display device of the above embodiment, it is preferable that the host processor have a function of controlling the pulse width of the write signal by controlling the length of a period of the dummy signal.

Another embodiment of the present invention is a display method for a display device which includes a source driver, a first pixel, and a second pixel. The first pixel and the second pixel are electrically connected to the source driver. The first pixel is located closer to the source driver than the second pixel is. The display method includes the steps of inputting a first write signal to the first pixel and inputting a second write signal to the second pixel. The pulse width of the second write signal is larger than the pulse width of the first write signal.

Another embodiment of the present invention is a display method for a display device which includes a source driver and first to M-th pixels (M is a natural number greater than or equal to 2) electrically connected to the source driver. The j-th pixel (j is a natural number greater than or equal to 2 and less than or equal to M) is located closer to the source driver than the (j+l)-th pixel (l is a natural number less than or equal to (M−j)) is. The display method includes the steps of inputting a first write signal to the j-th pixel and inputting a second write signal to the (j+l)-th pixel. The pulse width of the second write signal is larger than the pulse width of the first write signal.

According to one embodiment of the present invention, the display evenness of a large or high-resolution display device can be improved. According to another embodiment of the present invention, the display quality of a large or high-resolution display device can be improved.

The effects of one embodiment of the present invention are not limited to the above effects. The effects described above do not disturb the existence of other effects. The other effects are ones that are not described above and will be described below. The other effects will be apparent from and can be derived from the description of the specification, the drawings, and the like by those skilled in the art. One embodiment of the present invention has at least one of the above effects and the other effects. Accordingly, one embodiment of the present invention does not have the aforementioned effects in some cases.

### BRIEF DESCRIPTION OF THE DRAWINGS

FIGS. 1A and 1B are block diagrams illustrating one embodiment of the present invention.

FIGS. 2A and 2B are circuit diagrams illustrating one embodiment of the present invention.

FIGS. 3A and 3B are timing charts illustrating one embodiment of the present invention.

FIG. 4 is a timing chart illustrating one embodiment of the present invention.

FIGS. 5A and 5B are a block diagram and a circuit diagram illustrating one embodiment of the present invention.

FIGS. 6A and 6B are a block diagram and a circuit diagram illustrating one embodiment of the present invention.

FIGS. 7A and 7B are circuit diagrams illustrating one embodiment of the present invention.

FIG. 8 is a perspective view of an example of a display panel.

FIG. 9 is a cross-sectional view illustrating an example of a display panel.

FIGS. 10A and 10B are top views illustrating an example of subpixels.

FIGS. 11A and 11B each illustrate an example of a display panel.

FIG. 12 illustrates an example of a display module.

FIGS. 13A to 13E illustrate examples of electronic devices.

### DETAILED DESCRIPTION OF THE INVENTION

Embodiments will be hereinafter described with reference to drawings. Note that embodiments can be carried out in many different modes, and it is easily understood by those skilled in the art that modes and details of the present invention can be modified in various ways without departing from the spirit and the scope of the present invention. Therefore, the present invention should not be interpreted as being limited to the description in the following embodiments.

Note that in the structures of the invention described below, the same portions or portions having similar functions are denoted by the same reference numerals in different drawings, and description of such portions is not repeated. Furthermore, the same hatch pattern is applied to similar functions, and these are not especially denoted by reference numerals in some cases.

In addition, the position, size, range, or the like of components illustrated in drawings is not accurately represented in some cases for easy understanding. Therefore, the disclosed invention is not necessarily limited to the position, size, range, or the like disclosed in the drawings.

In this specification and the like, a semiconductor device refers to a device that utilizes semiconductor characteristics, and means a circuit including a semiconductor element (e.g., a transistor, a diode, or a photodiode), a device including the circuit, and the like. The semiconductor device also means any device that can function by utilizing semiconductor characteristics. For example, an integrated circuit, a chip including an integrated circuit, and an electronic component including a chip in a package are examples of the semiconductor device. Moreover, a storage device, a display device, a light-emitting device, a lighting device, an electronic device, and the like themselves might be semiconductor devices, or might each include a semiconductor device.

In this specification and the like, a description “X and Y are connected” means that X and Y are electrically connected, X and Y are functionally connected, and X and Y are directly connected. Accordingly, without being limited to a predetermined connection relation, for example, a connection relation shown in drawings or text, another connection relation is included in the drawings or the text. Here, X and Y each denote an object (e.g., a device, an element, a circuit, a wiring, an electrode, a terminal, a conductive film, or a layer).

A transistor has three terminals: a gate, a source, and a drain. A gate is a control node that controls the conduction state of a transistor. Depending on the channel type of the transistor or levels of potentials applied to the terminals, one of two input/output nodes functions as a source and the other functions as a drain. Therefore, the terms “source” and “drain” can be interchanged in this specification and the like. In this specification and the like, the two terminals other than the gate may be referred to as a first terminal and a second terminal or as a third terminal and a fourth terminal.

A node can be referred to as a terminal, a wiring, an electrode, a conductive layer, a conductor, an impurity region, or the like depending on a circuit configuration, a device structure, and the like. Furthermore, a terminal, a wiring, or the like can be referred to as a node.

A voltage usually refers to a potential difference between a given potential and a reference potential (e.g., a ground potential or a source potential). Thus, a voltage can be referred to as a potential. Note that a potential has a relative value; therefore, GND does not necessarily mean 0 V.

In this specification and the like, ordinal numbers such as “first,” “second,” and “third” are used to show the order in some cases. Alternatively, ordinal numbers are used to avoid confusion among components in some cases, and do not limit the number or order of the components. For example, it is possible to replace the term “first” with the term “second” or “third” in describing one embodiment of the present invention.

In addition, the position, size, range, or the like of components illustrated in drawings is not accurately represented in some cases for easy understanding. Therefore, the disclosed invention is not necessarily limited to the position, size, range, or the like disclosed in the drawings.

Note that the terms “film” and “layer” can be interchanged with each other depending on the case or circumstances. For example, the term “conductive layer” can be changed into the term “conductive film.” Also, the term “insulating film” can be changed into the term “insulating layer.”

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, a metal oxide used in a semiconductor layer of a transistor is called an oxide semiconductor in some cases. In other words, an OS FET is a transistor including a metal oxide or an oxide semiconductor.

In this specification and the like, a metal oxide including nitrogen is also called a metal oxide in some cases. Moreover, a metal oxide including nitrogen may be called a metal oxynitride.

### Embodiment 1

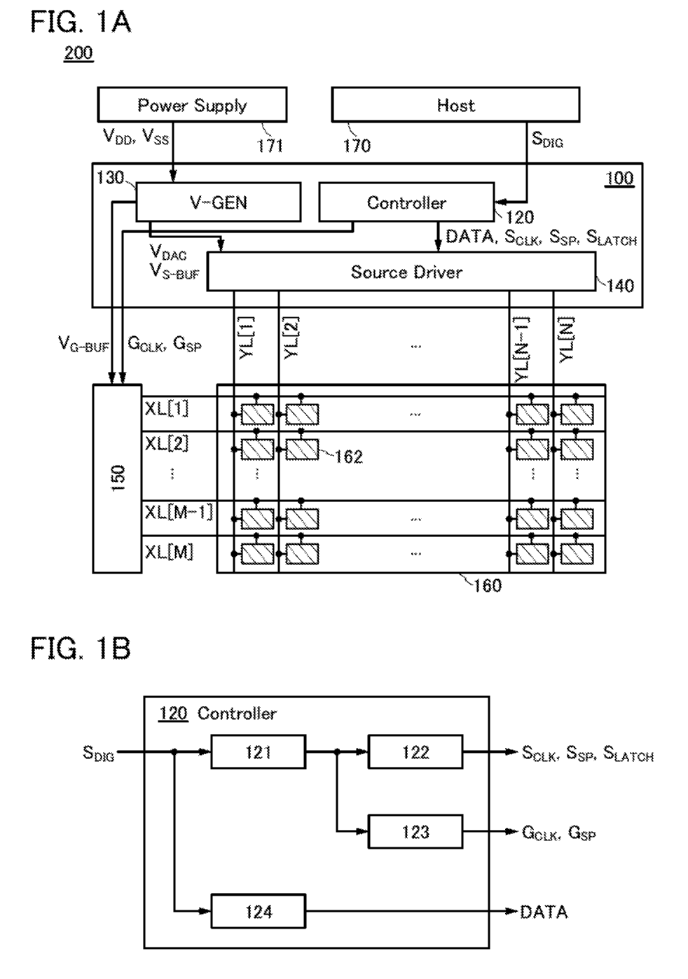

In this embodiment, a display device of one embodiment of the present invention will be described with reference to FIGS. 1A and 1B, FIGS. 2A and 2B, FIGS. 3A and 3B, FIG. 4, FIGS. 5A and 5B, FIGS. 6A and 6B, and FIGS. 7A and 7B.

FIG. 1A is a block diagram illustrating a display device 200 which is one example of the display device of one embodiment of the present invention. FIG. 1B is a block diagram illustrating a display controller included in the display device 200.

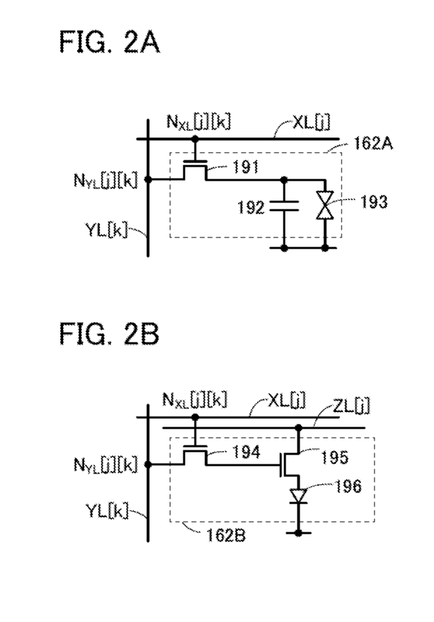

FIGS. 2A and 2B are circuit diagrams each illustrating a pixel included in the display device 200.

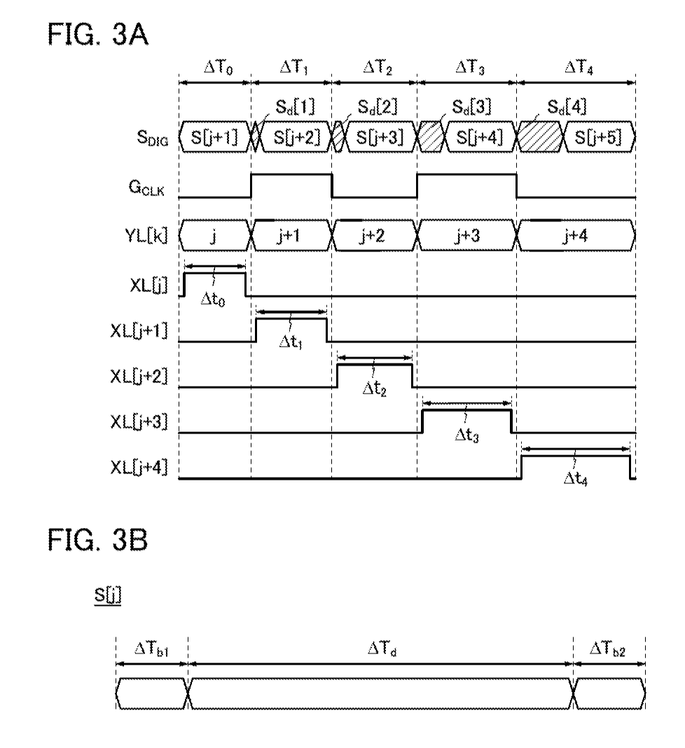

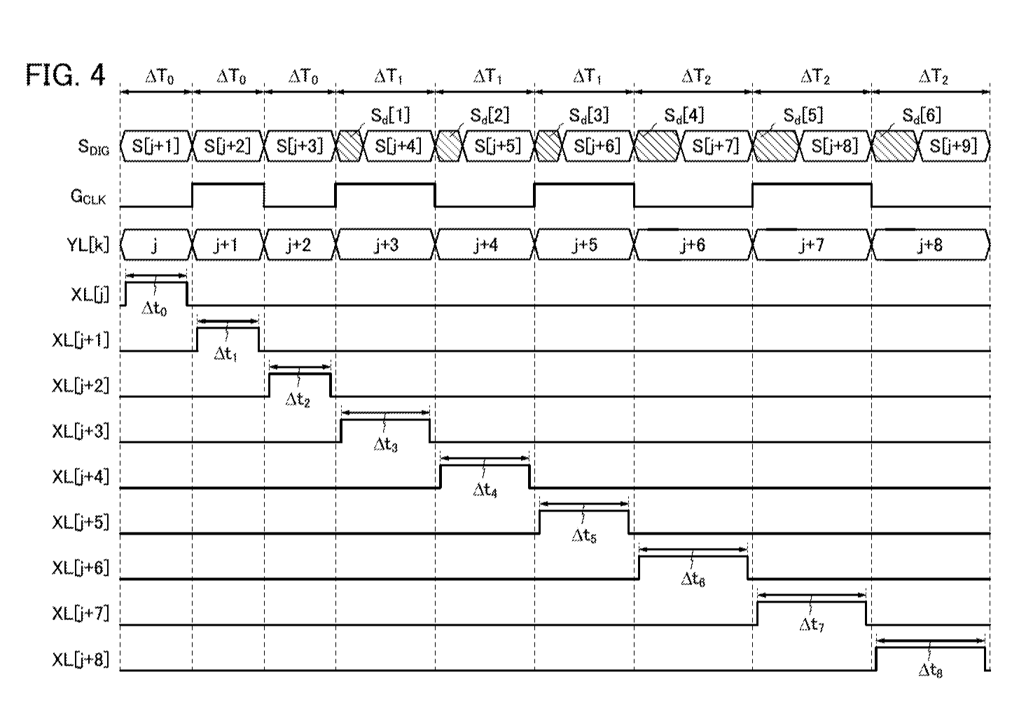

FIGS. 3A and 3B and FIG. 4 are timing charts illustrating methods for driving the display device 200.

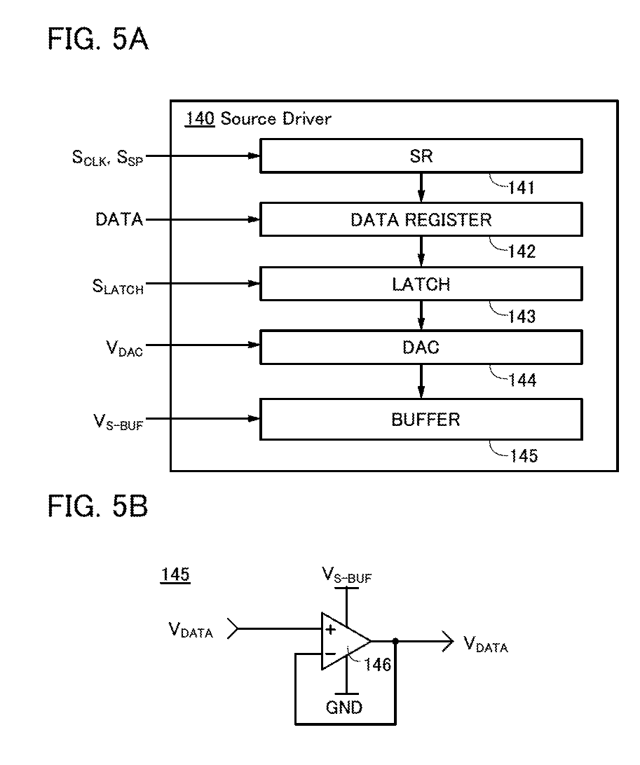

FIGS. 5A and 5B are a block diagram and a circuit diagram illustrating a source driver included in the display device 200.

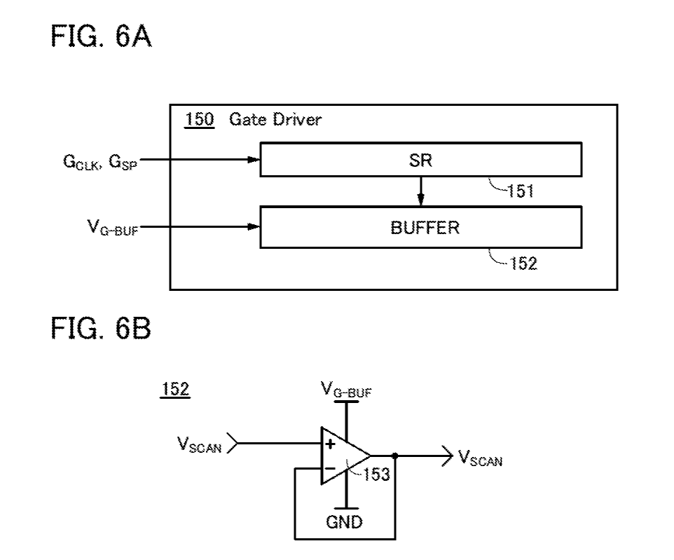

FIGS. 6A and 6B are a block diagram and a circuit diagram illustrating a gate driver included in the display device 200.

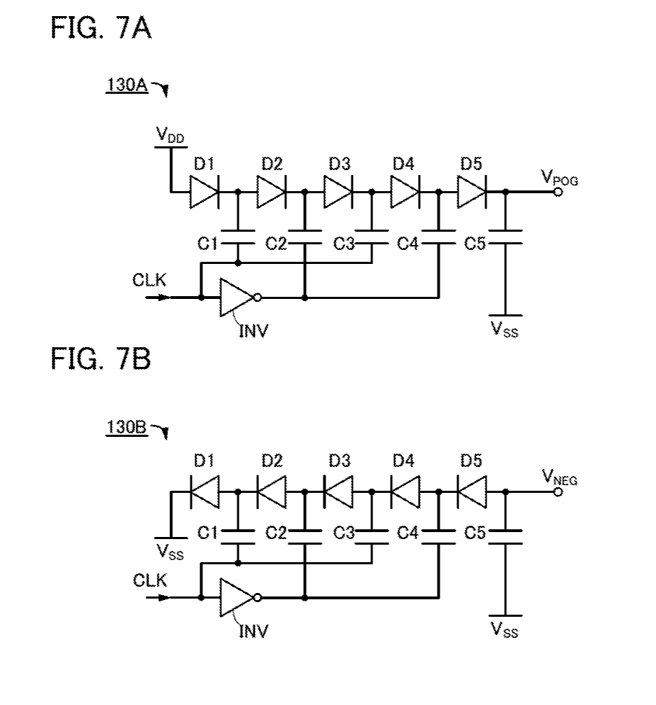

FIGS. 7A and 7B are circuit diagrams each illustrating a voltage generator circuit included in the display device 200.

First, a configuration of the display device of one embodiment of the present invention is described with reference to FIG. 1A and FIG. 3A.

As illustrated in FIG. 1A, the display device 200 includes a display driver IC 100, a gate driver 150, scan lines XL[1] to XL[M] (M is a natural number greater than or equal to 2), signal lines YL[1] to YL[N] (N is a natural number greater than or equal to 2), and a pixel portion 160.

The display driver IC 100 includes a source driver 140, a display controller 120, and a voltage generator circuit 130.

A digital signal Sum output from a host processor 170 is input to the display controller 120 (shown as “Controller” in the diagrams) through an interface. On the basis of the digital signal S_{DIG}, the display controller 120 supplies control signals for the source driver 140, control signals for the gate driver 150, and display data DATA. The control signals for the source driver 140 are a clock signal S_{CLK}, a start pulse S_{SP}, and a latch signal S_{LATCH}, for example. The control signals for the gate driver 150 are a clock signal G_{CLK} and a start pulse G_{SP}, for example.

FIG. 1B illustrates an example of a configuration of the display controller 120 included in the display driver IC 100. In FIG. 1B, the display controller 120 includes a reference clock generator circuit 121, a horizontal clock generator circuit 122, a vertical clock generator circuit 123, and a video signal processing circuit 124.

In the display controller 120 illustrated in FIG. 1B, the reference clock generator circuit 121 generates a reference clock from the digital signal S_{DIG}. This reference clock is input to the horizontal clock generator circuit 122 and the vertical clock generator circuit 123. From the reference clock, the horizontal clock generator circuit 122 generates the control signals for the source driver 140, such as the clock signal SILK, the start pulse S_{SP}, and the latch signal S_{LATCH}. In addition, from the reference clock, the vertical clock generator circuit 123 generates the control signals for the gate driver 150, such as the clock signal G_{CLK} and the start pulse G_{SP}.

In the display controller 120 illustrated in FIG. 1B, the video signal processing circuit 124 generates the display data DATA from the digital signal S_{DIG}.

Note that the digital signal S_{DIG} is output from the host processor 170 in FIG. 1A, but the configuration of the display device of one embodiment of the present invention is not limited thereto. A signal output from the host processor or the like may be input to the display controller 120 as the digital signal S_{DIG} through, for example, a timing controller, a frame memory, or the like.

A voltage V_{DD} and a voltage V_{SS} that serve as reference voltages output from a power supply 171 (shown as “Power Supply” in the diagram) are input to the voltage generator circuit 130 (shown as “V-GEN” in the diagram). Note that the voltage V_{SS} is preferably a ground voltage GND. The voltage generator circuit 130 generates voltages for driving the source driver 140 and the gate driver 150 on the basis of the voltage V_{DD} and the voltage V_{SS}. Voltages output to the source driver 140 are a voltage V_{DAC} and a voltage V_{S-BUF}, for example. A voltage output to the gate driver 150 is a voltage V_{G-BUF}, for example.

The source driver 140 converts the display data DATA into a data voltage (V_{DATA}) in accordance with the voltage V_{DAC}, the voltage Vs-Bur, and the control signals (the clock signal S_{CLK}, the start pulse S_{SP}, and the latch signal S_{LATCH}) and outputs the data voltage (V_{DATA}). A detailed configuration of the source driver 140 will be described later.

The gate driver 150 is electrically connected to the scan lines XL[1] to XL[M]. The gate driver 150 outputs a scan voltage (V_{SCAN}) to the scan lines XL[1] to XL[M] in accordance with the voltage V_{G-BUF} and the control signals (the clock signal G_{CLK} and the start pulse G_{SP}). A detailed configuration of the gate driver 150 will be described later.

The signal lines YL[1] to YL[N] are sequentially arranged substantially parallel to each other in a region overlapping with the pixel portion 160. The signal lines YL[1] to YL[N] are electrically connected to the source driver 140. In addition, the signal lines YL[1] to YL[N] are electrically connected to the pixel portion 160.

The scan lines XL[1] to XL[M] are sequentially arranged substantially parallel to each other in a region overlapping with the pixel portion 160. The scan lines XL[1] to XL[M] are electrically connected to the gate driver 150. In addition, the scan lines XL[1] to XL[M] are electrically connected to the pixel portion 160.

Note that in this specification and the like, among the signal lines YL[1] to YL[N], the signal line closest to the gate driver 150 is referred to as the signal line YL[1], and the signal line farthest from the gate driver 150 is referred to as the signal line YL[N]. Furthermore, in this specification and the like, among the scan lines XL[1] to XL[M], the scan line closest to the source driver 140 is referred to as the scan line XL[1], and the scan line farthest from the source driver 140 is referred to as the scan line XL[M].

The signal lines YL[1] to YL[N] are arranged so as to each intersect the scan lines XL[1] to XL[M] at substantially right angles.

The pixel portion 160 includes pixels 162 arranged in M rows and N columns.

The pixel 162 is described here with reference to FIGS. 2A and 2B.

The pixel 162 includes a transistor, a capacitor, and a display element. The pixel 162 is electrically connected to one signal line and one scan line. FIGS. 2A and 2B each illustrate a configuration example of the pixel 162. Note that in each of FIGS. 2A and 2B, a pixel in a j-th row and a k-th column (j is a natural number less than or equal to M and k is a natural number less than or equal to N) is illustrated as a pixel in a given row and a given column.

The data voltage that is output from the source driver 140 is input to the pixel 162 through the signal line. The scan voltage that is output from the gate driver 150 is input to the pixel 162 through the scan line.

Examples of the display element that can be used in the pixel 162 include a liquid crystal element and a light-emitting element.

As the light-emitting element that can be used in the pixel 162, a self-luminous element can be used, and an element whose luminance is controlled by current or voltage is included in the category of the light-emitting element. For example, an LED, an organic EL element, an inorganic EL element, or the like can be used.

The light-emitting element has a top emission structure, a bottom emission structure, a dual emission structure, or the like. A conductive film that transmits visible light is used as an electrode through which light is extracted. A conductive film that reflects visible light is preferably used as an electrode through which light is not extracted.

An EL layer includes at least a light-emitting layer. In addition to the light-emitting layer, the EL layer may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

Either a low molecular compound or a high molecular compound can be used for the EL layer, and an inorganic compound may also be included. Each of the layers included in the EL layer can be formed by any of the following methods: an evaporation method (including a vacuum evaporation method), a transfer method, a printing method, an inkjet method, a coating method, and the like.

When a voltage higher than the threshold voltage of the light-emitting element is applied between a cathode and an anode, holes are injected to the EL layer from the anode side and electrons are injected to the EL layer from the cathode side. The injected electrons and holes are recombined in the EL layer, so that a light-emitting substance contained in the EL layer emits light.

In the case where a light-emitting element emitting white light is used as the light-emitting element, the EL layer preferably contains two or more kinds of light-emitting substances. For example, light-emitting substances are selected so that two or more light-emitting substances emit complementary colors to obtain white light emission. Specifically, it is preferable to contain two or more light-emitting substances selected from light-emitting substances emitting light of red (R), green (G), blue (B), yellow (Y), orange (O), and the like and light-emitting substances emitting light containing two or more of spectral components of R, G, and B. The light-emitting element preferably emits light with a spectrum having two or more peaks in the wavelength range of a visible light region (e.g., 350 nm to 750 nm). An emission spectrum of a material emitting light having a peak in the wavelength range of yellow light preferably includes spectral components also in the wavelength ranges of green light and red light.

A light-emitting layer containing a light-emitting material emitting light of one color and a light-emitting layer containing a light-emitting material emitting light of another color are preferably stacked in the EL layer. For example, the plurality of light-emitting layers in the EL layer may be stacked in contact with each other or may be stacked with a region not including any light-emitting material therebetween. For example, between a fluorescent layer and a phosphorescent layer, a region containing the same material as the one in the fluorescent layer or phosphorescent layer (for example, a host material or an assist material) and no light-emitting material may be provided. This facilitates the manufacture of the light-emitting element and reduces the drive voltage.

The light-emitting element may be a single element including one EL layer or a tandem element in which a plurality of EL layers are stacked with a charge generation layer therebetween.

Details of the liquid crystal element that can be used in the pixel 162 will be described in a later embodiment.

FIG. 2A illustrates a pixel 162A as an example in the case of using a liquid crystal element as the display element. The pixel 162A includes a transistor 191, a capacitor 192, and a liquid crystal element 193.

A gate of the transistor 191 is electrically connected to the scan line XL[j] at a node N_{XL}[j][k]. One of a source and a drain of the transistor 191 is electrically connected to the signal line YL[k] at a node N_{YL}[j][k]. The other of the source and the drain of the transistor 191 is electrically connected to the capacitor 192 and the liquid crystal element 193.

The transistor 191 serves as a switching element for controlling the connection between the liquid crystal element 193 and the signal line YL[k]. For example, when a pulse signal is input to the gate of the transistor 191 from the gate driver 150 through the scan line XL[j], the transistor 191 is turned on, the signal line YL[k] and the liquid crystal element 193 are electrically connected to each other, and display data is written to the liquid crystal element 193.

FIG. 2B illustrates a pixel 162B as an example of a pixel configuration in the case of using a light-emitting element as the display element. The pixel 162B includes a transistor 194, a transistor 195, and a light-emitting element 196. FIG. 2B illustrates a current supply line ZL[j] in addition to the scan line XL[j] and the signal line YL[k]. The current supply line ZL[j] is a wiring for supplying current to the light-emitting element 196.

A gate of the transistor 194 is electrically connected to the scan line XL[j] at the node N_{XL}[j][k]. One of a source and a drain of the transistor 194 is electrically connected to the signal line YL[k] at the node N_{YL}[j][k]. The other of the source and the drain of the transistor 194 is electrically connected to a gate of the transistor 195.

One of a source and a drain of the transistor 195 is electrically connected to the current supply line ZL[j]. The other of the source and the drain of the transistor 195 is electrically connected to the light-emitting element 196.

The transistor 194 serves as a switching element for controlling the connection between the gate of the transistor 195 and the signal line YL[k]. For example, when a pulse signal is input to the gate of the transistor 194 from the gate driver 150 through the scan line XL[j], the transistor 194 is turned on, the signal line YL[k] and the gate of the transistor 195 are electrically connected to each other, and the data voltage (V_{DATA}) is input to the gate of the transistor 195. In addition, display data is written to the light-emitting element 196 by control of a current flowing to the light-emitting element 196 from the current supply line ZL[j] depending on the voltage applied to the gate of the transistor 195.

In this specification and the like, a pulse signal that is input to the pixel 162 from the gate driver 150 in order to write display data to the display element may be referred to as a write signal or a scan voltage. Specifically, for example, a pulse signal that is input to the gate of the transistor 191 from the gate driver 150 through the scan line XL[j] in order to write display data to the liquid crystal element 193 of the pixel 162A may be referred to as a write signal or a scan voltage. Furthermore, a pulse signal that is input to the gate of the transistor 194 from the gate driver 150 through the scan line XL[j] in order to write display data to the light-emitting element 196 of the pixel 162B may be referred to as a write signal or a scan voltage.

The above is the description of the pixel 162.

Note that in this specification and the like, the scan line XL[j] refers to a scan line connected to a plurality of pixels arranged in the j-th row. The signal line YL[k] refers to a signal line connected to a plurality of pixels arranged in the k-th column.

In this specification and the like, a determination of whether one pixel (a first pixel) is located closer to the display driver IC 100 or the source driver 140 than another pixel (a second pixel) is or whether the second pixel is located closer to the display driver IC 100 or the source driver 140 than the first pixel is may be made by, for example, the scan lines connected to the first pixel and the second pixel.

For example, in the case where the first pixel is connected to the j-th scan line and the second pixel is connected to the (j+l)-th scan line (l is a natural number less than or equal to (M−j)), it can be determined that the first pixel is located closer to the display driver IC 100 or the source driver 140 than the second pixel is.

In this specification and the like, a determination of whether one pixel (a first pixel) is located closer to the display driver IC 100 or the source driver 140 than another pixel (a second pixel) is or whether the second pixel is located closer to the display driver IC 100 or the source driver 140 than the first pixel is may be made by, for example, comparing a distance between one point in the display driver IC 100 or the source driver 140 and one point in the first pixel with a distance between the one point in the display driver IC 100 or the source driver 140 and one point in the second pixel.

The above is a configuration of the display device of one embodiment of the present invention.

The display device of one embodiment of the present invention changes the pulse width of the write signal depending on the location of the pixel 162 to which the write signal is to be input.

Specifically, the pulse width of the write signal that is input to the pixel 162 located close to the display driver IC 100 is decreased, and the pulse width of the write signal that is input to the pixel 162 located away from the display driver IC 100 is increased. This ensures that the scan voltage is written to the pixel 162 even in the case where it takes time to increase the scan voltage that is input to the pixel 162 located away from the display driver IC 100.

Specifically, for example, the pulse width of the write signal that is input to the pixel in the (j+l)-th row and the k-th column is made larger than the pulse width of the write signal that is input to the pixel in the j-th row and the k-th column. This ensures that the scan voltage is written to the pixel in the (j+l)-th row and the k-th column even in the case where a voltage increase at a node N_{YL}[j+l][k] electrically connected to the pixel in the (j+l)-th row and the k-th column is slower than a voltage increase at the node N_{YL}[j][k] electrically connected to the pixel in the j-th row and the k-th column.

Thus, in one embodiment of the present invention, it can be ensured that the scan voltage is written to the pixel 162 regardless of its location even in the case where the increase or decrease rate of the data voltage varies depending on the location of the pixel 162. In other words, even in the case where the increase or decrease rate of the data voltage at a node on the scan line connected to the pixel 162 varies depending on the location of the node, it can be ensured that the data voltage is written to the pixel 162 regardless of the location of the node.

Next, a specific example of a method for driving the display device of one embodiment of the present invention is described with reference to FIGS. 3A and 3B.

The digital signal S_{DIG} illustrated in FIGS. 1A and 1B includes digital signals S[1] to SM. The digital signals S[1] to S[M] each contain display data for display by pixels in a certain row. For example, a given digital signal S[j] contains data for display by pixels in the j-th row. Note that periods of the digital signals S[1] to S[M] have an equal length.

The digital signal S_{DIG} may include a dummy signal between the digital signal S[j] and a digital signal S[j+1]. The display device of one embodiment of the present invention can control the pulse width of the write signal for each row by adjusting the length of a period of the dummy signal.

FIG. 3B is an example of a timing chart for the digital signal S[j]. The digital signal S[j] illustrated in FIG. 3A includes a first blank period ΔT_{b1}, a data period ΔT_{d}, and a second blank period ΔT_{b2}.

The digital signal S[j] contains data for display by the pixels in the j-th row in the data period ΔT_{d}. The digital signal S[j] also contains trigger data in either the first blank period ΔT_{b1} or the second blank period ΔT_{b2} or both.

The display device of one embodiment of the present invention can control the clock signal G_{CLK} and the clock signal S_{CLK} by using the trigger data contained in the digital signal S[j]. This enables the clock signal G_{CLK} and the clock signal SILK to be synchronized with the digital signal S_{DIG}. In addition, the display device of one embodiment of the present invention can control the clock signal G_{CLK}, the clock signal S_{CLK}, the start pulse G_{SP}, and the start pulse S_{SP} illustrated in FIG. 1A by using the trigger data contained in the digital signal S[j].

FIG. 3A is a timing chart illustrating examples of the digital signal S_{DIG}, the clock signal G_{CLK}, and signals that are input to the signal line YL[k], the scan line XL[j], a scan line XL[j+1], a scan line XL[j+2], a scan line XL[j+3], and a scan line XL[j+4]. Note that the timing chart in FIG. 3A illustrates periods for inputting write signals to pixels in the j-th row, the (j+1)-th row, the (l+2)-th row, the (j+3)-th row, and the (j+4)-th row.

In FIG. 3A, the digital signal S_{DIG} includes the digital signal S[j+1], a dummy signal S_{d}[1], a digital signal S[j+2], a dummy signal S_{d}[2], a digital signal S[j+3], a dummy signal S_{d}[3], a digital signal S[j+4], a dummy signal S_{d}[4], and a digital signal S[j+5].

As illustrated in FIG. 3A, in some cases described below, a period in which the digital signal S_{DIG} is the digital signal S[j+1] is referred to as a period ΔT₀; a period in which the digital signal S_{DIG} is the dummy signal S_{d}[1] or the digital signal S[j+2] is referred to as a period ΔT₁; a period in which the digital signal S_{DIG} is the dummy signal S_{d}[2] or the digital signal S[j+3] is referred to as a period ΔT₂; a period in which the digital signal S_{DIG} is the dummy signal S_{d}[3] or the digital signal S[j+4] is referred to as a period ΔT₃; and a period in which the digital signal S_{DIG} is the dummy signal S_{d}[4] or the digital signal S[j+5] is referred to as a period ΔT₄.

As illustrated in FIG. 3A, the periods of the dummy signal S_{d}[1], the dummy signal S_{d}[2], the dummy signal S_{d}[3], and the dummy signal S_{d}[4] gradually become longer in this order. Therefore, the magnitude relationship between the period ΔT₀, the period ΔT₁, the period ΔT₂, the period ΔT₃, and the period ΔT₄ can be expressed as follows: ΔT₀≤ΔT₁≤ΔT₂≤ΔT₃≤ΔT₄.

The clock signal G_{CLK} is controlled by the trigger data contained in the digital signal S_{DIG} and synchronized with the digital signal S_{DIG}, as described above. Thus, the frequency of the clock signal G_{CLK} changes dynamically in some cases. For example, the potential of the clock signal G_{CLK} is low in the period ΔT₀, high in the period ΔT₁, low in the period ΔT₂, high in the period ΔT₃, and low in the period ΔT₄. According to the above-described relationship ΔT₀≤ΔT₁≤ΔT₂≤ΔT₃≤ΔT₄, it can be said that the frequency of the clock signal G_{CLK} may be decreased during a period from the period ΔT₀ to the period ΔT₄ in some cases.

It can also be said that the frequency of the clock signal G_{CLK} may change depending on the length of the period of the dummy signal.

In the period ΔT₀, data for display by the pixels in the j-th row is supplied to the signal line YL[k]. In addition, in the period ΔT₀, a write signal with a pulse width Δt₀ (Δt₀≤ΔT₀) is supplied to the scan line XL[j].

In the period ΔT₁, data for display by the pixels in the (j+1)-th row is supplied to the signal line YL[k]. In addition, in the period ΔT₁, a write signal with a pulse width Δt₁ (Δt₁≤ΔT₁) is supplied to the scan line XL[j+1].

In the period ΔT₂, data for display by the pixels in the (j+2)-th row is supplied to the signal line YL[k]. In addition, in the period ΔT₂, a write signal with a pulse width Δt₂ (Δt₂≤ΔT₂) is supplied to the scan line XL[j+2].

In the period ΔT₃, data for display by the pixels in the (j+3)-th row is supplied to the signal line YL[k]. In addition, in the period ΔT₃, a write signal with a pulse width Δt₃ (Δt₃≤ΔT₃) is supplied to the scan line XL[j+3].

In the period ΔT₄, data for display by the pixels in the (j+4)-th row is supplied to the signal line YL[k]. In addition, in the period ΔT₄, a write signal with a pulse width Δt₄ (Δt₄≤ΔT₄) is supplied to the scan line XL[j+4].

According to the above-described relationship ΔT₀≤ΔT₁≤ΔT₂≤ΔT₃≤ΔT₄, the magnitude relationship between the widths of the write signals supplied to the scan lines XL [j] to XL[j+4] can be expressed as follows: Δt₀≤Δt₁≤Δt₂≤Δt₃≤Δt₄.

Note that FIGS. 3A and 3B illustrate the example in which the write signals that are input to the adjacent scan lines have different pulse widths. However, one embodiment of the present invention is not limited to this example, and the write signals that are input to the adjacent scan lines may have an equal pulse width in some cases.

An example of a driving method in which the write signals that are input to the adjacent scan lines have an equal pulse width in some periods is described with reference to FIG. 4.

FIG. 4 is a timing chart illustrating examples of the digital signal S_{DIG}, the clock signal G_{CLK}, and signals that are input to the signal line YL[k], the scan lines XL[j] to XL[j+4], and scan lines XL[j+5] to XL[j+8]. Note that the timing chart in FIG. 4 illustrates periods for inputting write signals to pixels in the j-th to (j+8)-th rows.

In FIG. 4, the digital signal S_{DIG} includes the digital signal S[j+1], the digital signal S[j+2], the digital signal S[j+3], the dummy signal S_{d}[1], the digital signal S[j+4], the dummy signal S_{d}[2], the digital signal S[j+5], the dummy signal S_{d}[3], a digital signal S[j+6], the dummy signal S_{d}[4], a digital signal S[j+7], a dummy signal S_{d}[5], a digital signal S[j+8], a dummy signal S_{d}[6], and a digital signal S[j+9].

In FIG. 4, no dummy signals are input between periods of the digital signal S[j+1] and the digital signal S[j+2] and between periods of the digital signal S[j+2] and the digital signal S[j+3]. Periods of the dummy signal S_{d}[1], the dummy signal S_{d}[2], and the dummy signal S_{d}[3] have an equal length. Periods of the dummy signal S_{d}[4], the dummy signal S_{d}[5], and the dummy signal S_{d}[6] have an equal length, and are longer than the periods of the dummy signal S_{d}[1], the dummy signal S_{d}[2], and the dummy signal S_{d}[3].

Thus, in FIG. 4, a period in which the digital signal S_{DIG} is the digital signal S[j+1], a period in which the digital signal S_{DIG} is the digital signal S[j+2], and a period in which the digital signal S_{DIG} is the digital signal S[j+3] have an equal length and can be represented by the period ΔT₀. A period in which the digital signal S_{DIG} is the dummy signal S_{d}[1] or the digital signal S[j+4], a period in which the digital signal S_{DIG} is the dummy signal S_{d}[2] or the digital signal S[j+5], and a period in which the digital signal S_{DIG} is the dummy signal S_{d}[3] or the digital signal S[j+6] have an equal length and can be represented by the period ΔT₁. A period in which the digital signal S_{DIG} is the dummy signal S_{d}[4] or the digital signal S[j+7], a period in which the digital signal S_{DIG} is the dummy signal S_{d}[5] or the digital signal S[j+8], and a period in which the digital signal S_{DIG} is the dummy signal S_{d}[6] or the digital signal S[j+9] have an equal length and can be represented by the period ΔT₂.

Therefore, in FIG. 4, the pulse width Δt₀ of the write signal supplied to the scan line XL[j], the pulse width Δt₁ of the write signal supplied to the scan line XL[j+1], and the pulse width Δt₂ of the write signal supplied to the scan line XL[j+2] may be equal to each other in some cases. The pulse width Δt₄ of the write signal supplied to the scan line XL[j+3], the pulse width Δt₄ of the write signal supplied to the scan line XL[j+4], and a pulse width Δt₅ of a write signal supplied to the scan line XL[j+5] may be equal to each other in some cases. A pulse width Δt₆ of a write signal supplied to the scan line XL[j+6], a pulse width Δt₇ of a write signal supplied to the scan line XL[j+7], and a pulse width Δt₈ of a write signal supplied to the scan line XL[j+8] may be equal to each other in some cases.

The above is the description of specific examples of methods for driving the display device of one embodiment of the present invention.

By using the above-described driving method, the display device of one embodiment of the present invention can change the pulse width of the write signal for each scan line, i.e., for each row of the pixels 162. Thus, it can be ensured that the scan voltage is written to the pixel 162 regardless of its location even in the case where the increase or decrease rate of the data voltage varies depending on the location of the pixel 162.

Accordingly, it can be ensured that the data voltage is written to a pixel regardless of its location even in the case where the increase or decrease rate of the data voltage varies depending on the location of the pixel owing to an increase in size or resolution of the display device of one embodiment of the present invention. Therefore, according to one embodiment of the present invention, display evenness of a large or high-resolution display device can be improved.

The display device of one embodiment of the present invention can suppress a decrease of the overall operating frequency by changing the pulse width of the write signal depending on the location of each pixel. Therefore, according to one embodiment of the present invention, the display quality of a large or high-resolution display device can be improved.

Next, a configuration of the source driver 140 is described with reference to FIGS. 5A and 5B.

The source driver 140 illustrated in FIG. 5A includes a shift register 141 (shown as “SR” in the diagram), a data register 142 (shown as “DATA REGISTER” in the diagram), a latch circuit 143 (shown as “LATCH” in the diagram), a digital-to-analog converter circuit 144 (shown as “DAC” in the diagram), and a buffer circuit 145 (shown as “BUFFER” in the diagram).

The clock signal SILK and the start pulse S_{SP} are signals for driving the shift register 141. The display data DATA is a signal retained in the data register 142. The latch signal S_{LATCH} is a signal for driving the latch circuit 143. The voltage V_{DAC} is a voltage for generating the data voltage (V_{DATA}), which is a gray level voltage, in the digital-to-analog converter circuit 144. The voltage V_{S-BUF} is a voltage applied as power for an operational amplifier in the buffer circuit 145.

FIG. 5B is an example of a circuit diagram of the operational amplifier included in the buffer circuit 145.

An operational amplifier 146 included in the buffer circuit 145 illustrated in FIG. 5B is supplied with the voltage V_{S-BUF} and outputs the data voltage V_{DATA}. An L-level voltage V_{S-BUF} is the ground voltage GND, and an H-level voltage V_{S-BUF} is the voltage V_{S-BUF}.

Next, a configuration of the gate driver 150 is described with reference to FIGS. 6A and 6B.

The gate driver 150 illustrated in FIG. 6A includes a shift register 151 (shown as “SR” in the diagram) and a buffer circuit 152 (shown as “BUFFER” in the diagram). The clock signal G_{CLK} and the start pulse G_{SP} are signals for driving the shift register 151. The voltage V_{G-BUF} is a voltage applied as power for an operational amplifier in the buffer circuit 152.

FIG. 6B is an example of a circuit diagram of the operational amplifier included in the buffer circuit 152.

An operational amplifier 153 included in the buffer circuit 152 illustrated in FIG. 6B is supplied with the voltage V_{G-BUF} and outputs the scan voltage V_{SCAN}. An L-level voltage V_{G-BUF} is the ground voltage GND, and an H-level voltage V_{G-BUF} is the voltage V_{G-BUF}.

Next, the voltage generator circuit 130 is described with reference to FIGS. 7A and 7B.

A voltage generator circuit 130A illustrated in FIG. 7A is a circuit that generates a voltage V_{POG}. The voltage generator circuit 130A can generate the voltage V_{POG} on the basis of the voltage V_{DD} and the voltage V_{SS} supplied from the external power supply 171. Thus, the display driver IC 100 can operate on the basis of the single power supply voltage supplied from the outside.

The voltage generator circuit 130A in FIG. 7A is a five-stage charge pump including diodes D1 to D5, capacitors C1 to C5, and an inverter INV. A clock signal CLK is supplied to the capacitors C1 to C5 directly or through the inverter INV. When a power supply voltage of the inverter INV is a voltage applied on the basis of the voltage V_{DD} and the voltage V_{SS}, the voltage V_{POG}, which has been increased to a positive voltage with a positively quintupled value of the voltage V_{DD} by application of the clock signal CLK, can be obtained. Note that a forward voltage of the diodes D1 to D5 is 0 V. A desired voltage V_{POG} can be obtained by changing the number of stages of the charge pump.

A voltage generator circuit 130B illustrated in FIG. 7B is a circuit that generates a voltage V_{NEG}. The voltage generator circuit 130B can generate the voltage V_{NEG} on the basis of the voltage V_{DD} and the voltage V_{SS} supplied from the external power supply 171. Thus, the display driver IC 100 can operate on the basis of the single power supply voltage supplied from the outside.

The voltage generator circuit 130B in FIG. 7B is a four-stage charge pump including the diodes D1 to D5, the capacitors C1 to C5, and the inverter INV. The clock signal CLK is supplied to the capacitors C1 to C5 directly or through the inverter INV. When the power supply voltage of the inverter INV is a voltage applied on the basis of the voltage V_{DD} and the voltage V_{SS}, the voltage V_{NEG}, which has been decreased from the voltage V_{SS} to a negative voltage with a negatively quadrupled value of the voltage V_{DD} by application of the clock signal CLK, can be obtained. Note that the forward voltage of the diodes D1 to D5 is 0 V. A desired voltage V_{NEG} can be obtained by changing the number of stages of the charge pump.

At least part of this embodiment can be implemented in combination with any of the other embodiments described in this specification as appropriate.

### Embodiment 2

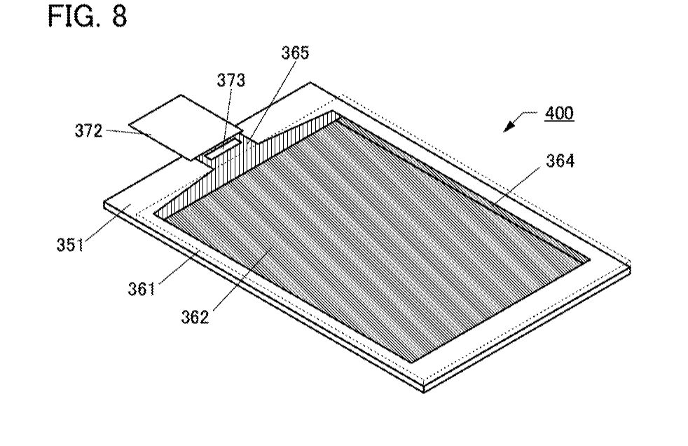

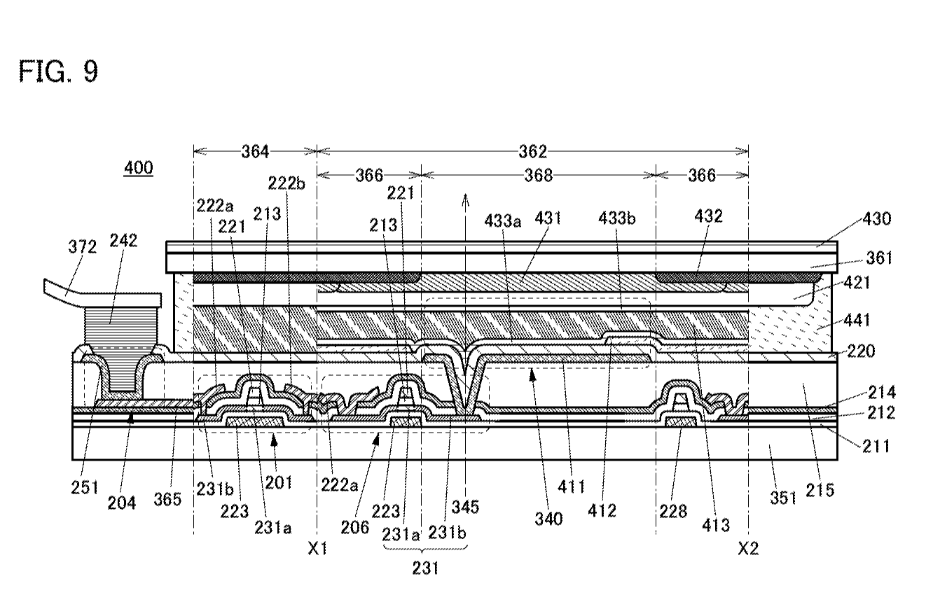

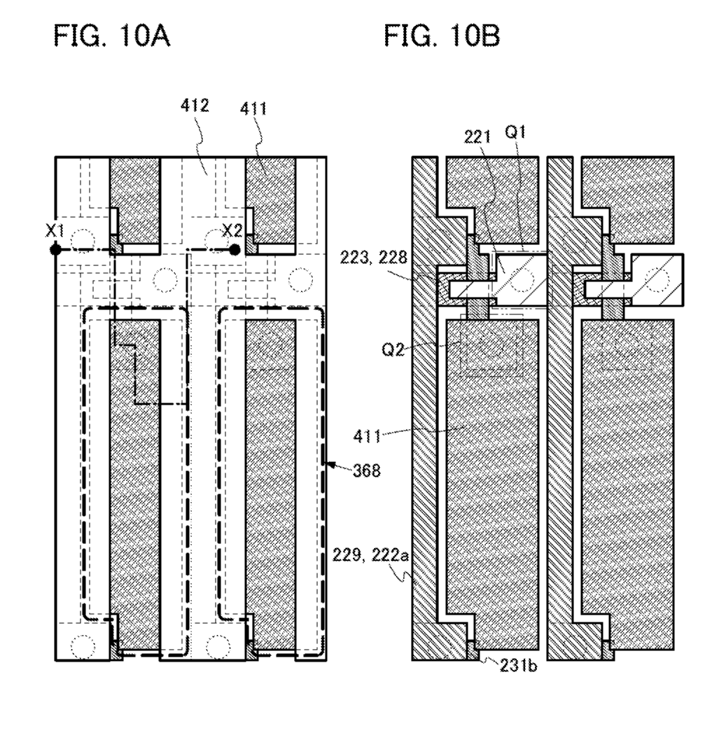

In this embodiment, a structure of a display panel that can be used in the display device of one embodiment of the present invention will be described with reference to FIG. 8, FIG. 9, and FIGS. 10A and 10B.

Note that in this embodiment, a display panel 400 that is an example of a display panel including a liquid crystal element as a display element is described as an example of the display panel that can be used in the display device of one embodiment of the present invention.

FIG. 8 is a perspective view of the display panel 400. For clarity, FIG. 8 does not illustrate some components such as a polarizer 430. FIG. 8 illustrates a substrate 361 with a dotted line. FIG. 9 is a cross-sectional view of the display panel 400. FIGS. 10A and 10B are top views of subpixels included in the display panel 400.

The display panel 400 includes a display portion 362 and a driver circuit portion 364. An FPC 372 and an IC 373 are mounted on the display panel 400.

The display portion 362 includes a plurality of pixels and has a function of displaying images. The display portion 362 also includes scan lines and signal lines.

Each of the pixels includes a plurality of subpixels. For example, a subpixel exhibiting a red color, a subpixel exhibiting a green color, and a subpixel exhibiting a blue color form one pixel, and thus full-color display can be achieved in the display portion 362. Note that the colors exhibited by subpixels are not limited to red, green, and blue. For example, a subpixel exhibiting white, yellow, magenta, cyan, or the like may be used for the pixel. Note that in this specification and the like, a subpixel is simply referred to as a pixel in some cases.

The display panel 400 includes a gate driver and a source driver.

The driver circuit portion 364 functions as the gate driver. When the display panel 400 includes a sensor such as a touch sensor, the display panel 400 may include a sensor driver circuit.

In the display panel 400, the IC 373 is mounted on a substrate 351 by a COG method or the like. The IC 373 includes, for example, any one or more of a source driver and a sensor driver circuit.

The FPC 372 is electrically connected to the display panel 400. The IC 373 and the driver circuit portion 364 are supplied with signals and power from the outside through the FPC 372. Furthermore, signals can be output to the outside from the IC 373 through the FPC 372.

An IC may be mounted on the FPC 372. For example, an IC including any one or more of a source driver and a sensor driver circuit may be mounted on the FPC 372.

Signals and power are supplied to the display portion 362 and the driver circuit portion 364 through a wiring 365. The signals and power are input to the wiring 365 from the outside through the FPC 372 or from the IC 373.

FIG. 9 is a cross-sectional view including the display portion 362, the driver circuit portion 364, and the wiring 365. FIG. 9 includes a cross-sectional view along dashed-dotted line X1-X2 in FIG. 10A. In FIG. 9, the display portion 362 includes a display region 368 in a subpixel and a non-display region 366 around the display region 368.

FIG. 10A is a top view of a stacked structure from a gate 223 to a common electrode 412 (see FIG. 9) in a subpixel, which is seen from the common electrode 412 side. In FIG. 10A, the display region 368 in the subpixel is outlined in a bold dotted line. FIG. 10B is a top view obtained by excluding the common electrode 412 from the stacked structure in FIG. 10A.

FIG. 9 shows an example in which the polarizer 430 is positioned on the substrate 361 side and a backlight unit (not illustrated) is positioned on the substrate 351 side. Light 345 from the backlight unit enters the substrate 351 first, passes through a contact area between a transistor 206 and a pixel electrode 411, a liquid crystal element 340, a coloring layer 431, the substrate 361, and the polarizer 430 in order, and then exits from the display panel 400.

The display panel 400 is an example of a transmissive liquid crystal display panel that includes a liquid crystal element with a horizontal electric field mode.

As illustrated in FIG. 9, the display panel 400 includes the substrate 351, a transistor 201, the transistor 206, the liquid crystal element 340, an alignment film 433a, an alignment film 433b, a connection portion 204, an adhesive layer 441, the coloring layer 431, a light-blocking layer 432, an overcoat 421, the substrate 361, the polarizer 430, and the like.

The transistor 206 is provided in the non-display region 366.

The transistor 206 includes a gate 221, the gate 223, an insulating layer 211, an insulating layer 213, and a semiconductor layer 231 (a channel formation region 231a and a pair of low-resistance regions 231b).

The gate 221 and the channel formation region 231a overlap with the insulating layer 213 positioned therebetween. The gate 223 and the channel formation region 231a overlap with the insulating layer 211 positioned therebetween. The insulating layers 211 and 213 serve as gate insulating layers. A conductive layer 222a is connected to one of the low-resistance regions 231b through an opening provided in insulating layers 212 and 214.

The resistivity of the low-resistance region 231b is lower than that of the channel formation region 231a. That is, the conductivity of the low-resistance region 231b is higher than that of the channel formation region 231a. The low-resistance region can also be referred to as an oxide conductor (OC). The low-resistance region 231b has a higher carrier concentration or a higher impurity concentration than the channel formation region 231a.

The semiconductor layer 231 can be formed with a light-transmitting semiconductor material. Examples of the light-transmitting semiconductor material include a metal oxide and an oxide semiconductor. An oxide semiconductor preferably contains at least indium. In particular, indium and zinc are preferably contained. In addition, one or more selected from aluminum, gallium, yttrium, tin, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

The low-resistance regions 231b are obtained by imparting n-type conductivity to the semiconductor layer 231. The low-resistance regions 231b are regions of the semiconductor layer 231 that are in contact with the insulating layer 212. Here, the insulating layer 212 preferably contains nitrogen or hydrogen, in which case nitrogen or hydrogen in the insulating layer 212 enters the low-resistance regions 231b to increase the carrier concentration of the low-resistance regions 231b. Alternatively, the low-resistance regions 231b may be formed by the addition of an impurity with the gate 221 used as a mask. Examples of the impurity include hydrogen, helium, neon, argon, fluorine, nitrogen, phosphorus, arsenic, antimony, boron, and aluminum. The impurity can be added by an ion implantation method or an ion doping method. Other than the above impurities, for example, indium, which is a constituent element of the semiconductor layer 231, may be added to form the low-resistance regions 231b. When indium is added to the low-resistance regions 231b, the concentration of indium in the low-resistance regions 231b is higher than that in the channel formation region 231a in some cases.

After the addition of the impurity, heat treatment may be performed (typically at higher than or equal to 100° C. and lower than or equal to 400° C., preferably at higher than or equal to 150° C. and lower than or equal to 350° C.).

The addition of the impurity can be applied to another oxide conductor (OC) as well as the low-resistance regions 231b.

The transistor 206 illustrated in FIG. 9 is a transistor including gates above and below the channel.

In a contact area Q1 illustrated in FIG. 10B, the gates 221 and 223 are electrically connected. A transistor having such a structure in which two gates are electrically connected to each other can have a higher field-effect mobility and thus have a higher on-state current than other transistors. Consequently, a circuit capable of high-speed operation can be obtained. Furthermore, the area occupied by a circuit portion can be reduced. The use of the transistor having a high on-state current can reduce signal delay in wirings and can reduce display unevenness even in a display panel in which the number of wirings is increased because of an increase in size or resolution. In addition, the use of such a structure allows the fabrication of a highly reliable transistor.

In a contact area Q2 illustrated in FIG. 10B, the low-resistance region 231b of the semiconductor layer is connected to the pixel electrode 411. The low-resistance region 231b is formed with a visible light transmitting material. Hence, the contact area Q2 can be provided in the display region 368. This can increase the aperture ratio of the subpixel. In addition, the power consumption of the display panel can be reduced.

In other words, in FIGS. 10A and 10B, one conductive layer serves as a scan line 228 and the gate 223. One of the gates 221 and 223 that has the lower resistance of the two is preferably the conductive layer that also serves as the scan line. The conductive layer that serves as the scan line 228 preferably has a sufficiently low resistance. Thus, the conductive layer that serves as the scan line 228 is preferably formed with a metal, an alloy, or the like. Alternatively, a material that has a function of blocking visible light may be used for the conductive layer serving as the scan line 228.

In other words, in FIGS. 10A and 10B, one conductive layer serves as a signal line 229 and the conductive layer 222a. The conductive layer that serves as the signal line 229 preferably has a sufficiently low resistance. Thus, the conductive layer that serves as the signal line 229 is preferably formed with a metal, an alloy, or the like. Alternatively, a material that has a function of blocking visible light may be used for the conductive layer serving as the signal line 229.

Specifically, some conductive materials that transmit visible light have higher resistivity than some conductive materials (e.g., copper and aluminum) that block visible light; hence, in order to prevent signal delay, a bus line such as a scan line or a signal line is preferably formed with a conductive material (a metal material) that has a low resistivity and blocks visible light. Note that a conductive material that transmits visible light can be used for the bus line depending on the size of a pixel, the width of the bus line, the thickness of the bus line, and the like.

The gates 221 and 223 can each include a single layer of one of a metal material and an oxide conductor, or stacked layers of both a metal material and an oxide conductor. For example, one of the gates 221 and 223 may include an oxide conductor, and the other of the gates 221 and 223 may include a metal material.

The transistor 206 can be formed to include an oxide semiconductor layer as the semiconductor layer, and include an oxide conductive layer as at least one of the gates 221 and 223. In this case, the oxide semiconductor layer and the oxide conductive layer are preferably formed using an oxide semiconductor.

When a conductive layer blocking visible light is used for the gate 223, light from a backlight can be prevented from entering the channel formation region 231a. The overlapping of the channel formation region 231a and the conductive layer that blocks visible light can reduce variations in the characteristics of the transistor due to light. This makes the transistor more reliable.

The light-blocking layer 432 is provided on the side of the channel formation region 231a that is closer to the substrate 361, and the gate 223 that blocks visible light is provided on the side of the channel formation region 231a that is closer to the substrate 351. Accordingly, the channel formation region 231a can be prevented from being irradiated with external light and light from the backlight.

In one embodiment of the present invention, the conductive layer that blocks visible light may overlap with part of the semiconductor layer and may not overlap with another part of the semiconductor layer. For example, the conductive layer that blocks visible light may overlap with at least the channel formation region 231a. Specifically, as illustrated in FIG. 9 and the like, the low-resistance regions 231b adjacent to the channel formation region 231a each include a region that does not overlap with the gate 223. Note that the low-resistance region 231b may be rephrased as the aforementioned oxide conductor (OC). Since the oxide conductor (OC) transmits visible light, light can be extracted through the low-resistance region 231b.

In the case where silicon, typically amorphous silicon, low-temperature polysilicon, or the like is used for the semiconductor layer of the transistor, the aforementioned low-resistance region corresponds to a region that includes silicon containing an impurity such as phosphorus or boron. Note that the band gap of silicon is approximately 1.1 eV. Thus, in the case where silicon is used for the semiconductor layer of the transistor, the semiconductor layer absorbs part of visible light, which makes it difficult to extract light through the semiconductor layer. The light-transmitting property might be further reduced when silicon contains an impurity such as phosphorus or boron. Hence, it is sometimes more difficult to extract light through the low-resistance region formed in silicon. In contrast, in one embodiment of the present invention, both the oxide semiconductor (OS) and the oxide conductor (OC) have visible light transmitting properties, leading to an increase in the aperture ratio of a pixel or a subpixel.

As illustrated in FIG. 9, the transistor 206 is covered by the insulating layers 212 and 214 and an insulating layer 215. Note that the insulating layers 212 and 214 can be considered as the components of the transistor 206. The transistor is preferably covered by an insulating layer that has an effect of reducing the diffusion of an impurity to the semiconductor included in the transistor. The insulating layer 215 can serve as a planarization layer.

Each of the insulating layers 211 and 213 preferably includes an excess oxygen region. When the gate insulating layer includes the excess oxygen region, excess oxygen can be supplied to the channel formation region 231a. A highly reliable transistor can be provided since oxygen vacancies that are potentially formed in the channel formation region 231a can be filled with excess oxygen.

The insulating layer 212 preferably includes nitrogen or hydrogen. Since the insulating layer 212 and the low-resistance region 231b are in contact with each other, nitrogen or hydrogen in the insulating layer 212 is added to the low-resistance region 231b. The carrier density of the low-resistance region 231b becomes high when nitrogen or hydrogen is added. Alternatively, when the insulating layer 214 includes nitrogen or hydrogen and the insulating layer 212 transmits nitrogen or hydrogen, nitrogen or hydrogen can be added to the low-resistance region 231b.

The liquid crystal element 340 is provided in the display region 368. The liquid crystal element 340 is a liquid crystal element with fringe field switching (FFS) mode.

The liquid crystal element 340 includes the pixel electrode 411, the common electrode 412, and a liquid crystal layer 413. The alignment of the liquid crystal layer 413 can be controlled with the electric field generated between the pixel electrode 411 and the common electrode 412. The liquid crystal layer 413 is positioned between the alignment films 433a and 433b.

The common electrode 412 may have a top-surface shape (also referred to as a planar shape) that has a comb-like shape or a top-surface shape that is provided with a slit. FIG. 9 and FIG. 10A illustrate an example where one opening is provided in the common electrode 412 in the display region 368 of one subpixel. One opening or a plurality of openings can be provided in the common electrode 412. As the display panel has higher resolution, the area of the display region 368 in one subpixel becomes smaller. Thus, the number of openings provided in the common electrode 412 is not limited to more than one; one opening can be provided. That is, in a display panel with high resolution, the area of the pixel (subpixel) is small; therefore, an adequate electric field for the alignment of liquid crystals over the entire display region of the subpixel can be generated, even when there is only one opening in the common electrode 412.

An insulating layer 220 is provided between the pixel electrode 411 and the common electrode 412. The pixel electrode 411 includes a portion that overlaps with the common electrode 412 with the insulating layer 220 provided therebetween. Furthermore, the common electrode 412 is not placed above the pixel electrode 411 in some areas of a region where the pixel electrode 411 and the coloring layer 431 overlap.

An alignment film is preferably provided in contact with the liquid crystal layer 413. The alignment film can control the alignment of the liquid crystal layer 413. In the display panel 400, the alignment film 433a is positioned between the common electrode 412 (or the insulating layer 220) and the liquid crystal layer 413, and the alignment film 433b is positioned between the overcoat 421 and the liquid crystal layer 413.

The liquid crystal material is classified into a positive liquid crystal material with a positive dielectric anisotropy (Δε) and a negative liquid crystal material with a negative dielectric anisotropy. Either of the materials can be used in one embodiment of the present invention, and an optimal liquid crystal material can be selected according to the employed mode and design.

In one embodiment of the present invention, a negative liquid crystal material is preferably used. The negative liquid crystal is less affected by a flexoelectric effect, which is attributed to the polarization of liquid crystal molecules, and thus the polarity of voltage applied to the liquid crystal layer makes little difference in transmittance. This prevents flickering from being recognized by the user of the display panel. The flexoelectric effect is a phenomenon in which polarization is induced by the distortion of orientation, and mainly depends on the shape of a molecule. The negative liquid crystal material is less likely to experience the distortion due to deformation such as spreading and bending.

Note that the liquid crystal element 340 is an element using an FFS mode here; however, one embodiment of the present invention is not limited thereto, and a liquid crystal element using any of a variety of modes can be used. For example, a liquid crystal element using a vertical alignment (VA) mode, a twisted nematic (TN) mode, an in-plane switching (IPS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, an electrically controlled birefringence (ECB) mode, a VA-IPS mode, or a guest-host mode can be used.

Furthermore, the display panel 400 may be a normally black liquid crystal display panel, for example, a transmissive liquid crystal display panel using a vertical alignment (VA) mode. Examples of the vertical alignment mode include a multi-domain vertical alignment (MVA) mode, a patterned vertical alignment (PVA) mode, and an advanced super view (ASV) mode.

The liquid crystal element is an element that controls transmission and non-transmission of light by optical modulation action of a liquid crystal. The optical modulation action of the liquid crystal is controlled by an electric field applied to the liquid crystal (including a horizontal electric field, a vertical electric field, and an oblique electric field). As the liquid crystal used for the liquid crystal element, a thermotropic liquid crystal, a low-molecular liquid crystal, a high-molecular liquid crystal, a polymer dispersed liquid crystal (PDLC), a ferroelectric liquid crystal, an anti-ferroelectric liquid crystal, or the like can be used. Such a liquid crystal material exhibits a cholesteric phase, a smectic phase, a cubic phase, a chiral nematic phase, an isotropic phase, or the like depending on conditions.

Alternatively, in the case of employing a horizontal electric field mode, a liquid crystal exhibiting a blue phase for which an alignment film is unnecessary may be used. A blue phase is one of liquid crystal phases, which is generated just before a cholesteric phase changes into an isotropic phase while temperature of cholesteric liquid crystal is increased. Since the blue phase appears only in a narrow temperature range, a liquid crystal composition in which 5 wt. % or more of a chiral material is mixed is used for the liquid crystal layer 413 in order to improve the temperature range. The liquid crystal composition that includes a liquid crystal exhibiting a blue phase and a chiral material has a short response time and exhibits optical isotropy, which makes the alignment process unnecessary. In addition, the liquid crystal composition that includes a liquid crystal exhibiting a blue phase and a chiral material has little viewing angle dependence. In addition, since an alignment film does not need to be provided and rubbing treatment is unnecessary, electrostatic discharge damage caused by the rubbing treatment can be prevented and defects or damage of the liquid crystal display panel in the manufacturing process can be reduced.

As the display panel 400 is a transmissive liquid crystal display panel, a conductive material that transmits visible light is used for both the pixel electrode 411 and the common electrode 412. A conductive material that transmits visible light is used for one or more of the conductive layers included in the transistor 206. Accordingly, a portion where the transistor 206 is provided can be used as the display region 368. FIG. 9 shows the example where a semiconductor material that transmits visible light is used for the semiconductor layer 231.

For example, a material containing one or more of indium (In), zinc (Zn), and tin (Sn) is preferably used for the conductive material that transmits visible light. Specifically, indium oxide, indium tin oxide (ITO), indium zinc oxide, indium oxide containing tungsten oxide, indium zinc oxide containing tungsten oxide, indium oxide containing titanium oxide, indium tin oxide containing titanium oxide, indium tin oxide containing silicon oxide (ITSO), zinc oxide, and zinc oxide containing gallium are given, for example. Note that a film containing graphene can be used as well. The film containing graphene can be formed, for example, by reducing a film containing graphene oxide.

Preferably, an oxide conductive layer is used for one or more of the pixel electrode 411 and the common electrode 412. The oxide conductive layer preferably includes one or more metal elements that are included in the semiconductor layer 231 of the transistor 206. For example, the pixel electrode 411 and the common electrode 412 each preferably contain indium and are each further preferably an oxide film containing In, M (M is Al, Ti, Ga, Y, Zr, La, Ce, Nd, Sn, or Hf), and Zn.

One or more of the pixel electrode 411 and the common electrode 412 may be formed with an oxide semiconductor. When two or more layers included in the display panel are formed using oxide semiconductors containing the same metal element, the same manufacturing apparatus (e.g., film-formation apparatus or processing apparatus) can be used in two or more steps; manufacturing cost can thus be reduced.

An oxide semiconductor is a semiconductor material whose resistance can be controlled by oxygen vacancies in the film of the semiconductor material and/or the concentration of impurities such as hydrogen or water in the film of the semiconductor material. Thus, the resistivity of the oxide conductive layer can be controlled by selecting treatment for increasing oxygen vacancies and/or impurity concentration in an oxide semiconductor layer, or treatment for reducing oxygen vacancies and/or impurity concentration in an oxide semiconductor layer.

Note that such an oxide conductive layer formed using an oxide semiconductor layer can be referred to as an oxide semiconductor layer having a high carrier density and a low resistance, an oxide semiconductor layer having conductivity, or an oxide semiconductor layer having high conductivity.

In addition, the manufacturing cost can be reduced by forming the oxide semiconductor layer and the oxide conductive layer using the same metal element. For example, the manufacturing cost can be reduced by using a metal oxide target with the same metal composition. By using the metal oxide target with the same metal composition, an etching gas or an etchant used in the processing of the oxide semiconductor layer can also be used for processing of the oxide conductive layer. Note that even when the oxide semiconductor layer and the oxide conductive layer have the same metal elements, these layers have different compositions in some cases. For example, metal elements in the film can be released during the fabrication process of the display panel, which results in a different metal composition.

For example, when a silicon nitride film containing hydrogen is used for the insulating layer 220, and an oxide semiconductor is used for the pixel electrode 411, the conductivity of the oxide semiconductor can be increased by hydrogen that is supplied from the insulating layer 220.

In the display panel 400, the coloring layer 431 and the light-blocking layer 432 are provided closer to the substrate 361 than the liquid crystal layer 413 is. The coloring layer 431 is positioned in a region that at least overlaps with the display region 368 of the subpixel. In the non-display region 366 of the pixel (subpixel), the light-blocking layer 432 is provided. The light-blocking layer 432 overlaps with at least a part of the transistor 206.

The overcoat 421 is preferably provided between the coloring layer 431 or the light-blocking layer 432 and the liquid crystal layer 413. The overcoat 421 can reduce the diffusion of an impurity contained in the coloring layer 431, the light-blocking layer 432, and the like into the liquid crystal layer 413.

The substrates 351 and 361 are bonded to each other with the adhesive layer 441. The liquid crystal layer 413 is sealed in a region that is surrounded by the substrates 351 and 361 and the adhesive layer 441.

When the display panel 400 functions as a transmissive liquid crystal display panel, two polarizers are positioned in such a way that the display portion 362 is sandwiched between the two polarizers. FIG. 9 illustrates the polarizer 430 on the substrate 361 side. The light 345 from a backlight provided on the outside of the polarizer on the substrate 351 side enters the display portion 362 through the polarizer (not illustrated). In this case, the optical modulation of the light can be controlled by controlling the alignment of the liquid crystal layer 413 with a voltage applied between the pixel electrode 411 and the common electrode 412. That is, the intensity of light that exits through the polarizer 430 can be controlled. Light excluding light in a particular wavelength range is absorbed by the coloring layer 431, and thus, exiting light is red, blue, or green light, for example.

In addition to the polarizer, a circular polarizer can be used, for example. An example of a circular polarizer is a stack including a linear polarizer and a quarter-wave retardation plate. The circular polarizer can reduce the viewing angle dependence of the display quality of the display panel.

The driver circuit portion 364 includes the transistor 201.

The transistor 201 includes the gate 221, the gate 223, the insulating layer 211, the insulating layer 213, the semiconductor layer 231 (the channel formation region 231a and the pair of low-resistance regions 231b), the conductive layer 222a, and a conductive layer 222b. One of the conductive layers 222a and 222b serves as a source, and the other serves as a drain. The conductive layer 222a is electrically connected to one of the low-resistance regions 231b, and the conductive layer 222b is electrically connected to the other of the low-resistance regions 231b.

The transistor in the driver circuit portion 364 does not necessarily have a function of transmitting visible light. Hence, the conductive layers 222a and 222b can be formed in the same process using the same material (preferably, a material with a low resistivity such as a metal).

In the connection portion 204, the wiring 365 and a conductive layer 251 are connected to each other, and the conductive layer 251 and a connector 242 are connected to each other. That is, in the connection portion 204, the wiring 365 is electrically connected to the FPC 372 through the conductive layer 251 and the connector 242. By employing this configuration, signals and power can be supplied from the FPC 372 to the wiring 365.

The wiring 365 can be formed with the same material and the same fabrication step as those used for the conductive layers 222a and 222b that are included in the transistor 201 and the conductive layer 222a that is included in the transistor 206. The conductive layer 251 can be formed with the same material and the same fabrication step as those used for the pixel electrode 411 that is included in the liquid crystal element 340. Fabricating the conductive layers included in the connection portion 204 in such a manner, i.e., using the same materials and the same fabrication processes as those used for the conductive layers in the display portion 362 and the driver circuit portion 364, is preferable because the number of process steps is not increased.

The transistors 201 and 206 may or may not have the same structure. That is, the transistors included in the driver circuit portion 364 and the transistors included in the display portion 362 may or may not have the same structure. In addition, the driver circuit portion 364 may have a plurality of transistors with different structures, and the display portion 362 may have a plurality of transistors with different structures. For example, a transistor including two gates that are electrically connected to each other is preferably used in one or more of a shift register circuit, a buffer circuit, and a protection circuit included in the gate driver.

### [Structural Example of Subpixel]

FIGS. 10A and 10B are top views of subpixels included in the display panel 400, as described above.

In the contact area Q1 illustrated in FIG. 10B, the gates 221 and 223 are electrically connected, as described above.

In the contact area Q2 illustrated in FIG. 10B, the low-resistance region 231b of the semiconductor layer is directly connected to the pixel electrode 411, as described above.

In the structure illustrated in FIGS. 10A and 10B, the low-resistance region 231b in the semiconductor layer that transmits visible light is directly connected to the pixel electrode 411. Hence, the contact area Q2 can be provided in the display region 368. The aperture ratio of the subpixel in FIGS. 10A and 10B can be increased. In addition, the power consumption of the display device can be reduced.

Although the semiconductor layer and the pixel electrode 411 are directly connected to each other in FIGS. 10A and 10B, they may be connected through a conductive layer that transmits visible light. However, when the semiconductor layer is directly connected to the pixel electrode 411, the conductive layer does not need to be formed, which simplifies the fabrication process and reduces the costs.

### [Materials]

Next, the details of the materials that can be used for components of the display panel of this embodiment and the like are described. Note that description on the components already described is omitted in some cases. The materials described below can be used as appropriate in a display panel, a touch panel, and components thereof which are described later.

### <<Substrate 361>>

There are no large limitations on the material of the substrate used in the display panel of one embodiment of the present invention; a variety of substrates can be used. For example, a glass substrate, a quartz substrate, a sapphire substrate, a semiconductor substrate, a ceramic substrate, a metal substrate, or a plastic substrate can be used.

The weight and thickness of the display panel can be reduced by using a thin substrate. Furthermore, a flexible display panel can be obtained by using a substrate that is thin enough to have flexibility.

The display panel of one embodiment of the present invention is fabricated by forming a transistor and the like over the fabrication substrate and then transferring the transistor and the like to another substrate. By using the fabrication substrate, a transistor with excellent characteristics or a transistor with low power consumption can be formed, a display panel with high durability can be formed, heat resistance of a display panel can be provided, or reduction in weight or thickness of a display panel can be achieved. Examples of a substrate to which a transistor is transferred include, in addition to the substrate over which the transistor can be formed, a paper substrate, a cellophane substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), and the like), a leather substrate, a rubber substrate, and the like.

### <<Transistors 201 and 206>>

A transistor included in the display panel of one embodiment of the present invention may have a top-gate structure or a bottom-gate structure. Gate electrodes may be provided above and below a channel. A semiconductor material used in the transistor is not particularly limited, and an oxide semiconductor, silicon, or germanium can be used, for example.

There is no particular limitation on the crystallinity of a semiconductor material used for the transistors, and an amorphous semiconductor or a semiconductor having crystallinity (a microcrystalline semiconductor, a polycrystalline semiconductor, a single crystal semiconductor, or a semiconductor partly including crystal regions) may be used. A semiconductor having crystallinity is preferably used, in which case the degradation of the transistor characteristics can be suppressed.

For example, a Group 14 element, a compound semiconductor, or an oxide semiconductor can be used for the semiconductor layer. Typically, a semiconductor including silicon, a semiconductor including gallium arsenide, or an oxide semiconductor including indium can be used for the semiconductor layer.

An oxide semiconductor is preferably used for the semiconductor in which the channel of a transistor is formed. In particular, using an oxide semiconductor with a wider bandgap than that of silicon is preferable. A semiconductor material having a wider bandgap and a lower carrier density than silicon is preferably used because an off-state current of the transistor can be reduced.

The details of the oxide semiconductor are described in Embodiment 3.

The use of an oxide semiconductor makes it possible to provide a highly reliable transistor in which a change in the electrical characteristics is reduced.

Charge accumulated in a capacitor through the transistor can be retained for a long time because of low off-state current of the transistor. The use of such a transistor in pixels allows a driver circuit to stop while the gray level of a displayed image is maintained. As a result, a display panel with extremely low power consumption is obtained.

The transistors 201 and 206 preferably include an oxide semiconductor layer that is highly purified to reduce the formation of oxygen vacancies. Accordingly, the current in an off state (off-state current) of the transistors can be made small. Accordingly, an electrical signal such as an image signal can be held for a long period, and a writing interval can be set long in an on state. Thus, the frequency of refresh operation can be reduced, which leads to an effect of reducing power consumption.

In the transistors 201 and 206, a relatively high field-effect mobility can be obtained, whereby high-speed operation is possible. The use of such transistors that are capable of high-speed operation in the display panel enables the fabrication of the transistor in the display portion and the transistors in the driver circuit portion over the same substrate. This means that a semiconductor device separately formed with a silicon wafer or the like does not need to be used as the driver circuit, which enables a reduction in the number of components in the display panel. In addition, using the transistor that can operate at high speed in the display portion also can enable the provision of a high-quality image.

### <<Insulating Layer>>

An organic insulating material or an inorganic insulating material can be used as an insulating material that can be used for the insulating layer, the overcoat, the spacer, or the like included in the display panel. Examples of an organic insulating material include an acrylic resin, an epoxy resin, a polyimide resin, a polyamide resin, a polyimide-amide resin, a siloxane resin, a benzocyclobutene-based resin, and a phenol resin. Examples of an inorganic insulating layer include a silicon oxide film, a silicon oxynitride film, a silicon nitride oxide film, a silicon nitride film, an aluminum oxide film, a hafnium oxide film, an yttrium oxide film, a zirconium oxide film, a gallium oxide film, a tantalum oxide film, a magnesium oxide film, a lanthanum oxide film, a cerium oxide film, and a neodymium oxide film.

### <<Conductive Layer>>

For the conductive layer such as the gate, the source, and the drain of a transistor and the wiring, the electrode, and the like of the display panel, a single-layer structure or a layered structure using any of metals such as aluminum, titanium, chromium, nickel, copper, yttrium, zirconium, molybdenum, silver, tantalum, and tungsten, or an alloy containing any of these metals as its main component can be used. For example, a two-layer structure in which a titanium film is stacked over an aluminum film; a two-layer structure in which a titanium film is stacked over a tungsten film; a two-layer structure in which a copper film is stacked over a molybdenum film; a two-layer structure in which a copper film is stacked over an alloy film containing molybdenum and tungsten; a two-layer structure in which a copper film is stacked over an alloy film containing copper, magnesium, and aluminum; a three-layer structure in which a titanium film or a titanium nitride film, an aluminum film or a copper film, and a titanium film or a titanium nitride film are stacked in this order; a three-layer structure in which a molybdenum film or a molybdenum nitride film, an aluminum film or a copper film, and a molybdenum film or a molybdenum nitride film are stacked in this order; or the like can be employed. For example, in the case where the conductive layer has a three-layer structure, it is preferable that each of the first and third layers be a film formed of titanium, titanium nitride, molybdenum, tungsten, an alloy containing molybdenum and tungsten, an alloy containing molybdenum and zirconium, or molybdenum nitride, and that the second layer be a film formed of a low-resistance material such as copper, aluminum, gold, silver, or an alloy containing copper and manganese. Note that light-transmitting conductive materials such as ITO, indium oxide containing tungsten oxide, indium zinc oxide containing tungsten oxide, indium oxide containing titanium oxide, indium tin oxide containing titanium oxide, indium zinc oxide, or ITSO may be used.

An oxide conductive layer may be formed by controlling the resistivity of the oxide semiconductor.

### <<Adhesive Layer 441>>

A curable resin such as a heat-curable resin, a photocurable resin, or a two-component type curable resin can be used for the adhesive layer 441. For example, an acrylic resin, a urethane resin, an epoxy resin, or a siloxane resin can be used.

### <<Connector 242>>

As the connector 242, for example, an anisotropic conductive film (ACF) or an anisotropic conductive paste (ACP) can be used.

<<Coloring layer 431>>

The coloring layer 431 is a coloring layer that transmits light in a specific wavelength range. Examples of materials that can be used for the coloring layer 431 include a metal material, a resin material, and a resin material containing a pigment or dye.

### <<Light-Blocking Layer 432>>

The light-blocking layer 432 is provided, for example, between adjacent coloring layers 431 for different colors. A black matrix formed with, for example, a metal material or a resin material containing a pigment or dye can be used as the light-blocking layer 432. Note that it is preferable to provide the light-blocking layer 432 also in a region other than the display portion 362, such as the driver circuit portion 364, in which case leakage of guided light or the like can be inhibited.

The thin films included in the display panel (i.e., the insulating film, the semiconductor film, the conductive film, and the like) can be formed by any of a sputtering method, a chemical vapor deposition (CVD) method, a vacuum evaporation method, a pulsed laser deposition (PLD) method, an atomic layer deposition (ALD) method, and the like. As examples of the CVD method, a plasma-enhanced CVD (PECVD) method or a thermal CVD method can be given. As an example of the thermal CVD method, a metal organic CVD (MOCVD) method can be given.

Alternatively, the thin films included in the display panel (i.e., the insulating film, the semiconductor film, the conductive film, and the like) can be formed by a method such as spin coating, dipping, spray coating, inkjet printing, dispensing, screen printing, or offset printing, or with a doctor knife, a slit coater, a roll coater, a curtain coater, or a knife coater.

The thin films included in the display panel can be processed using a photolithography method or the like. Alternatively, island-shaped thin films may be formed by a film formation method using a shielding mask. Alternatively, the thin films may be processed by a nanoimprinting method, a sandblasting method, a lift-off method, or the like. Examples of the photolithography method include a method in which a resist mask is formed over a thin film to be processed, the thin film is processed by etching or the like, and the resist mask is removed, and a method in which a photosensitive thin film is formed and processed into a desired shape by light exposure and development.

As light used for light exposure in a photolithography method, light with an i-line (with a wavelength of 365 nm), light with a g-line (with a wavelength of 436 nm), light with an h-line (with a wavelength of 405 nm), and light in which the i-line, the g-line, and the h-line are mixed can be given. Alternatively, ultraviolet light, KrF laser light, ArF laser light, or the like can be used. Light exposure may be performed by liquid immersion exposure technique. As light used for light exposure, extreme ultra-violet light (EUV), X-rays, or the like can be given. An electron beam can be used instead of the light used for light exposure. It is preferable to use extreme ultra-violet light, X-rays, or an electron beam because extremely minute processing can be performed. Note that when light exposure is performed by scanning with a beam such as an electron beam, a photomask is not needed.

For etching of the thin film, a dry etching method, a wet etching method, a sandblast method, or the like can be used.

At least part of this embodiment can be implemented in combination with any of the other embodiments described in this specification as appropriate.

### Embodiment 3

Described in this embodiment is a metal oxide that can be used in a semiconductor layer of a transistor disclosed in one embodiment of the present invention. Note that in the case where a metal oxide is used in a semiconductor layer of a transistor, the metal oxide can be rephrased as an oxide semiconductor.

Oxide semiconductors can be classified into a single crystal oxide semiconductor and a non-single-crystal oxide semiconductor. Examples of the non-single-crystal oxide semiconductor include a c-axis-aligned crystalline oxide semiconductor (CAAC-OS), a polycrystalline oxide semiconductor, a nanocrystalline oxide semiconductor (nc-OS), an amorphous-like oxide semiconductor (a-like OS), and an amorphous oxide semiconductor.

For the semiconductor layer of the transistor disclosed in one embodiment of the present invention, a cloud-aligned composite oxide semiconductor (CAC-OS) may be used.

Note that the above-described non-single-crystal oxide semiconductor or CAC-OS can be suitably used for the semiconductor layer of the transistor disclosed in one embodiment of the present invention. As the non-single-crystal oxide semiconductor, the nc-OS or the CAAC-OS can be suitably used.

In one embodiment of the present invention, the CAC-OS is preferably used for the semiconductor layer of the transistor. With the use of the CAC-OS, the transistor can have excellent electrical characteristics or high reliability.

The CAC-OS will be described in detail below.

The CAC-OS or a CAC metal oxide has a conducting function in a part of the material and has an insulating function in another part of the material; as a whole, the CAC-OS or the CAC metal oxide has a function of a semiconductor. In the case where the CAC-OS or the CAC metal oxide is used in a channel formation region of a transistor, the conducting function is to allow electrons (or holes) serving as carriers to flow, and the insulating function is to not allow electrons serving as carriers to flow. By the complementary action of the conducting function and the insulating function, the CAC-OS or the CAC metal oxide can have a switching function (on/off function). In the CAC-OS or the CAC metal oxide, separation of the functions can maximize each function.

The CAC-OS or the CAC metal oxide includes conductive regions and insulating regions. The conductive regions have the above-described conducting function, and the insulating regions have the above-described insulating function. In some cases, the conductive regions and the insulating regions in the material are separated at the nanoparticle level. In some cases, the conductive regions and the insulating regions are unevenly distributed in the material. The conductive regions are observed to be coupled in a cloud-like manner with their boundaries blurred, in some cases.

Furthermore, in the CAC-OS or the CAC metal oxide, the conductive regions and the insulating regions each have a size of more than or equal to 0.5 nm and less than or equal to 10 nm, preferably more than or equal to 0.5 nm and less than or equal to 3 nm and are dispersed in the material, in some cases.

The CAC-OS or the CAC metal oxide includes components having different bandgaps. For example, the CAC-OS or the CAC metal oxide includes a component having a wide gap due to the insulating region and a component having a narrow gap due to the conductive region. In the case of such a composition, carriers mainly flow in the component having a narrow gap. The component having a narrow gap complements the component having a wide gap, and carriers also flow in the component having a wide gap in conjunction with the component having a narrow gap. Therefore, in the case where the above-described CAC-OS or CAC metal oxide is used in a channel formation region of a transistor, high current drive capability in the on state of the transistor, that is, high on-state current and high field-effect mobility, can be obtained.

In other words, the CAC-OS or the CAC metal oxide can be called a matrix composite or a metal matrix composite.

The CAC-OS has, for example, a composition in which elements included in a metal oxide are unevenly distributed. Materials including unevenly distributed elements each have a size of greater than or equal to 0.5 nm and less than or equal to 10 nm, preferably greater than or equal to 1 nm and less than or equal to 2 nm, or a similar size. Note that in the following description of a metal oxide, a state in which one or more metal elements are unevenly distributed and regions including the metal element(s) are mixed is referred to as a mosaic pattern or a patch-like pattern. The region has a size of greater than or equal to 0.5 nm and less than or equal to 10 nm, preferably greater than or equal to 1 nm and less than or equal to 2 nm, or a similar size.

Note that a metal oxide preferably contains at least indium. In particular, indium and zinc are preferably contained. In addition, one or more selected from aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

For example, of the CAC-OS, an In—Ga—Zn oxide with the CAC composition (such an In—Ga—Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{Z2}, where X2, Y2, and Z2 are real numbers greater than 0), and gallium oxide (GaO_{X3}, where X3 is a real number greater than 0) or gallium zinc oxide (Ga_{X4}Zn_{Y4}O_{Z4}, where X4, Y4, and Z4 are real numbers greater than 0), and a mosaic pattern is formed. Then, InO_{X1} or In_{X2}Zn_{Y2}O_{Z2} forming the mosaic pattern is evenly distributed in the film. This composition is also referred to as a cloud-like composition.

That is, the CAC-OS is a composite metal oxide with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is greater than the atomic ratio of In to the element M in a second region, the first region has higher In concentration than the second region.

Note that a compound including In, Ga, Zn, and O is also known as IGZO.

Typical examples of IGZO include a crystalline compound represented by InGaO₃(ZnO)ₘ₁ (m1 is a natural number) and a crystalline compound represented by In₍₁₊ₓ₀₎Ga₍₁₋ₓ₀₎O₃(ZnO)ₘ₀ (−1≤x0≤1; m0 is a given number).

The above crystalline compounds have a single crystal structure, a polycrystalline structure, or a c-axis-aligned crystalline (CAAC) structure. Note that the CAAC structure is a crystal structure in which a plurality of IGZO nanocrystals have c-axis alignment and are connected in the a-b plane direction without alignment.

On the other hand, the CAC-OS relates to the material composition of a metal oxide. In a material composition of a CAC-OS including In, Ga, Zn, and O, nanoparticle regions including Ga as a main component are observed in part of the CAC-OS and nanoparticle regions including In as a main component are observed in part thereof. These nanoparticle regions are randomly dispersed to form a mosaic pattern. Therefore, the crystal structure is a secondary element for the CAC-OS.

Note that in the CAC-OS, a stacked-layer structure including two or more films with different atomic ratios is not included. For example, a two-layer structure of a film including In as a main component and a film including Ga as a main component is not included.

A boundary between the region including GaO_{X3} as a main component and the region including In_{X2}Zn_{Y2}O_{Z2} or InO_{X1} as a main component is not clearly observed in some cases.

In the case where one or more of aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium in a CAC-OS, nanoparticle regions including the selected metal element(s) as a main component(s) are observed in part of the CAC-OS and nanoparticle regions including In as a main component are observed in part thereof, and these nanoparticle regions are randomly dispersed to form a mosaic pattern in the CAC-OS.

The CAC-OS can be formed by a sputtering method under conditions where a substrate is not heated, for example. In the case of forming the CAC-OS by a sputtering method, one or more selected from an inert gas (typically, argon), an oxygen gas, and a nitrogen gas may be used as a deposition gas. The ratio of the flow rate of an oxygen gas to the total flow rate of the deposition gas at the time of deposition is preferably as low as possible, and for example, the flow ratio of an oxygen gas is preferably higher than or equal to 0% and less than 30%, further preferably higher than or equal to 0% and less than or equal to 10%.

The CAC-OS is characterized in that no clear peak is observed in measurement using θ/2θ scan by an out-of-plane method, which is an X-ray diffraction (XRD) measurement method. That is, X-ray diffraction shows no alignment in the a-b plane direction and the c-axis direction in a measured region.

In an electron diffraction pattern of the CAC-OS which is obtained by irradiation with an electron beam with a probe diameter of 1 nm (also referred to as a nanometer-sized electron beam), a ring-like region with high luminance and a plurality of bright spots in the ring-like region are observed. Therefore, the electron diffraction pattern indicates that the crystal structure of the CAC-OS includes a nanocrystal (nc) structure with no alignment in plan-view and cross-sectional directions.

For example, an energy dispersive X-ray spectroscopy (EDX) mapping image confirms that an In—Ga—Zn oxide with the CAC composition has a structure in which a region including GaO_{X3} as a main component and a region including In_{X2}Zn_{Y2}O_{Z2} or InO_{X1} as a main component are unevenly distributed and mixed.

The CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{Z2} or InO_{X1} as a main component are separated to form a mosaic pattern.

The conductivity of a region including In_{X2}Zn_{Y2}O_{Z2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of an oxide semiconductor is exhibited. Accordingly, when regions including In_{X2}Zn_{Y2}O_{Z2} or InO_{X1} as a main component are distributed in an oxide semiconductor like a cloud, high field-effect mobility (μ) can be achieved.

In contrast, the insulating property of a region including GaO_{X3} or the like as a main component is higher than that of a region including In_{X2}Zn_{Y2}O_{Z2} or InO_{X1} as a main component. In other words, when regions including GaO_{X3} or the like as a main component are distributed in an oxide semiconductor, leakage current can be suppressed and favorable switching operation can be achieved.

Accordingly, when a CAC-OS is used for a semiconductor element, the insulating property derived from GaO_{X3} or the like and the conductivity derived from In_{X2}Zn_{Y2}O_{Z2} or InO_{X1} complement each other, whereby high on-state current (Ion) and high field-effect mobility (μ) can be achieved.

A semiconductor element including a CAC-OS has high reliability. Thus, the CAC-OS is suitably used in a variety of semiconductor devices typified by a display.

This embodiment can be combined with any other embodiment as appropriate.

### Embodiment 4

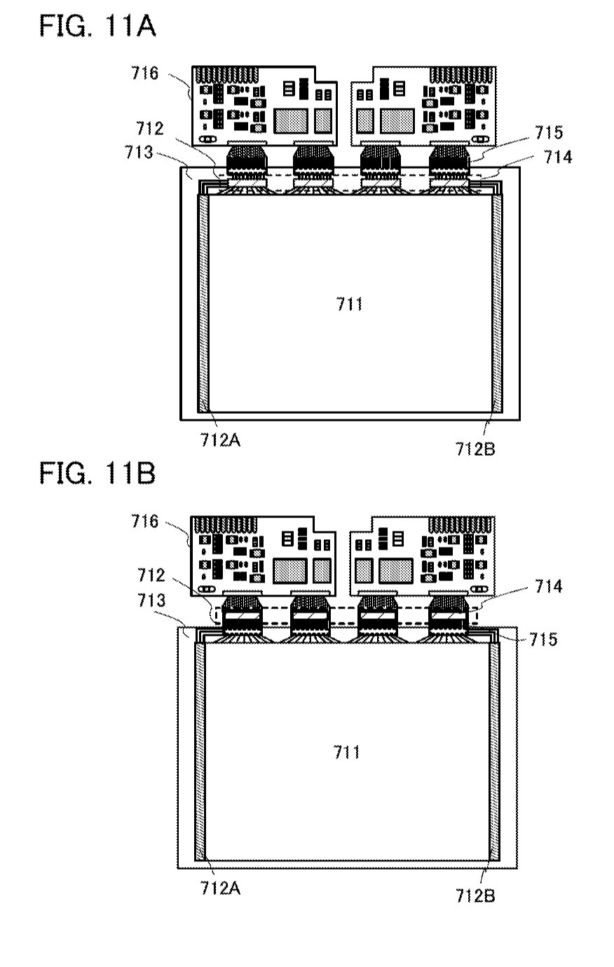

In this embodiment, another structural example of a display panel that can be used in the display device of one embodiment of the present invention. In addition, in this embodiment, application examples of the display device described in the foregoing embodiment to a display module and application examples of the display device to an electronic device will be described with reference to FIGS. 11A and 11B, FIG. 12, and FIGS. 13A to 13E.

### <Examples of Mounting IC on Display Panel>

FIGS. 11A and 11B each illustrate a structural example of the display panel that can be used in the display device of one embodiment of the present invention.

In FIG. 11A, a source driver 712 and gate drivers 712A and 712B are provided around a display portion 711 of the display panel, and a display driver IC 714 is mounted on a substrate 713 as the source driver 712.

The display driver IC 714 is mounted on the substrate 713 using an anisotropic conductive adhesive and an anisotropic conductive film.

The display driver IC 714 is connected to an external circuit board 716 via an FPC 715.

In the example of FIG. 11B, the source driver 712 and the gate drivers 712A and 712B are provided around the display portion 711, and the display driver IC 714 is mounted on the FPC 715 as the source driver 712.

Mounting the display driver IC 714 on the FPC 715 allows a larger display portion 711 to be provided over the substrate 713, resulting in a narrower frame.

### <Application Example of Display Module>

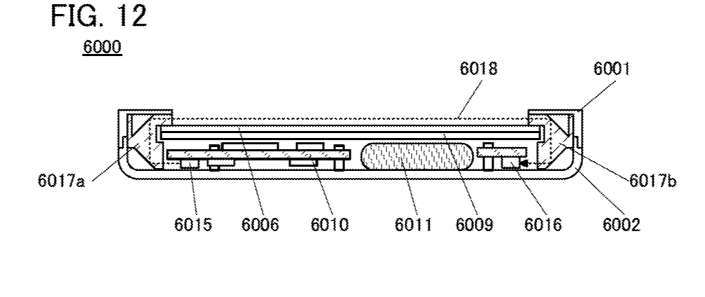

Next, an application example of a display module using the display panel illustrated in FIG. 8 or the display panel illustrated in FIG. 11A or FIG. 11B will be described with reference to FIG. 12.

FIG. 12 is a cross-sectional schematic view of a display module 6000 with an optical touch sensor.

The display module 6000 includes a light-emitting portion 6015 and a light-receiving portion 6016 provided on a printed circuit board 6010. A pair of light guide portions (a light guide portion 6017a and a light guide portion 6017b) is provided in a region surrounded by an upper cover 6001 and a lower cover 6002.

For example, a plastic or the like can be used for the upper cover 6001 and the lower cover 6002. The upper cover 6001 and the lower cover 6002 can each be thin (e.g., more than or equal to 0.5 mm and less than or equal to 5 mm). In that case, the display module 6000 can be significantly lightweight. In addition, the upper cover 6001 and the lower cover 6002 can be manufactured with a small amount of material, and therefore, manufacturing cost can be reduced.

A display panel 6006 overlaps with the printed circuit board 6010 and a battery 6011 with a frame 6009 located therebetween. The display panel 6006 and the frame 6009 are fixed to the light guide portion 6017a and the light guide portion 6017b.

Light 6018 emitted from the light-emitting portion 6015 travels over the display panel 6006 through the light guide portion 6017a and reaches the light-receiving portion 6016 through the light guide portion 6017b. For example, blocking of the light 6018 by a sensing target such as a finger or a stylus can be detected as touch operation.

A plurality of light-emitting portions 6015 are provided along two adjacent sides of the display panel 6006, for example. A plurality of light-receiving portions 6016 are provided so as to face the light-emitting portions 6015. Accordingly, information about the position of touch operation can be obtained.

As the light-emitting portion 6015, a light source such as an LED element can be used. It is particularly preferable to use a light source that emits infrared light, which is not visually recognized by users and is harmless to users, as the light-emitting portion 6015.

As the light-receiving portion 6016, a photoelectric element that receives light emitted by the light-emitting portion 6015 and converts it into an electrical signal can be used. A photodiode that can receive infrared light can be favorably used.

For the light guide portions 6017a and 6017b, members that transmit at least the light 6018 can be used. With the use of the light guide portions 6017a and 6017b, the light-emitting portion 6015 and the light-receiving portion 6016 can be placed under the display panel 6006, and a malfunction of the touch sensor due to external light reaching the light-receiving portion 6016 can be suppressed. It is particularly preferable to use a resin which absorbs visible light and transmits infrared light. This is more effective in suppressing the malfunction of the touch sensor.

### <Application Examples of Display Device to Electronic Device>

Next, an electronic device using the above display module for a display panel will be described. Examples of the electronic device include a computer, a portable information terminal (including a mobile phone, a portable game machine, and an audio reproducing device), electronic paper, a television device (also referred to as television or television receiver), and a digital video camera.

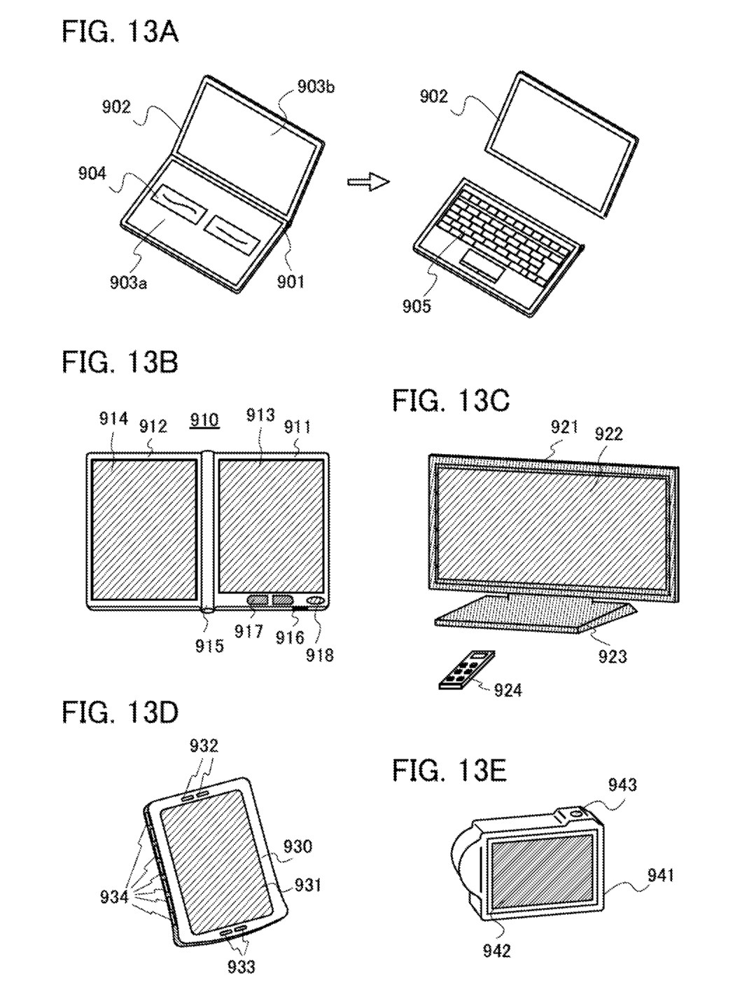

FIG. 13A illustrates a portable information terminal that includes a housing 901, a housing 902, a first display portion 903a, a second display portion 903b, and the like. At least one of the housings 901 and 902 includes the display module including the display device of the foregoing embodiment. Thus, it is possible to obtain a portable information terminal with a smaller circuit area.

Note that the first display portion 903a is a panel having a touch input function, and for example, as illustrated in the left of FIG. 13A, whether “touch input” is performed or whether “keyboard input” is performed can be selected with a selection button 904 displayed on the first display portion 903a. Since selection buttons with a variety of sizes can be displayed, the portable information terminal can be easily used by people of any generation. For example, when “keyboard input” is selected, a keyboard 905 is displayed on the first display portion 903a as illustrated in the right of FIG. 13A. Thus, for example, letters can be input quickly by key input as in the case of using a conventional information terminal.

One of the first and second display portions 903a and 903b can be detached from the portable information terminal as shown in the right of FIG. 13A. Providing the second display portion 903b with a touch input function makes the portable information terminal convenient to carry because the weight can be further reduced and the portable information terminal can be operated with one hand while the other hand supports the housing 902.

The portable information terminal in FIG. 13A can be equipped with a function of displaying a variety of information (e.g., a still image, a moving image, and a text image); a function of displaying a calendar, a date, the time, or the like on the display portion; a function of operating or editing information displayed on the display portion; a function of controlling processing by various kinds of software (programs); and the like. Furthermore, an external connection terminal (an earphone terminal, a USB terminal, or the like), a recording medium insertion portion, and the like may be provided on the back surface or the side surface of the housing.

The portable information terminal illustrated in FIG. 13A may be capable of transmitting and receiving data wirelessly. Through wireless communication, desired book data or the like can be purchased and downloaded from an e-book server. It is preferable that an image be displayed in the second display portion 903b by the display method described in Embodiment 1, in which case display quality can be improved.

In addition, the housing 902 illustrated in FIG. 13A may be equipped with an antenna, a microphone function, and/or a wireless communication function to be used as a mobile phone.

FIG. 13B illustrates an e-book reader 910 in which electronic paper is incorporated. The e-book reader has two housings of a housing 911 and a housing 912. The housing 911 and the housing 912 are provided with a display portion 913 and a display portion 914, respectively. The housings 911 and 912 are connected by a hinge 915 and can be opened or closed with the hinge 915 as an axis. The housing 911 is provided with a power switch 916, an operation key 917, a speaker 918, and the like. It is preferable that an image be displayed in the display portion 914 by the display method described in Embodiment 1, in which case display quality can be improved.

FIG. 13C illustrates a television device including a housing 921, a display portion 922, a stand 923, and the like. The television device can be operated with a switch of the housing 921 and/or a remote controller 924. It is preferable that an image be displayed in the display portion 922 by the display method described in Embodiment 1, in which case display quality can be improved.

FIG. 13D illustrates a smartphone in which a main body 930 is provided with a display portion 931, a speaker 932, a microphone 933, operation buttons 934, and the like. It is preferable that an image be displayed in the display portion 931 by the display method described in Embodiment 1, in which case display quality can be improved.

FIG. 13E illustrates a digital camera including a main body 941, a display portion 942, an operation switch 943, and the like. It is preferable that an image be displayed in the display portion 942 by the display method described in Embodiment 1, in which case display quality can be improved.

At least part of this embodiment can be implemented in combination with any of the other embodiments described in this specification as appropriate.

This application is based on Japanese Patent Application Serial No. 2016-249720 filed with Japan Patent Office on Dec. 22, 2016, the entire contents of which are hereby incorporated by reference.

What is claimed is:

1. A display device comprising:
a source driver;
a first pixel in a first row and a second pixel in a second row; and
a gate driver configured to supply a first write signal to the first pixel and supply a second write signal to the second pixel,
wherein the first pixel is closer to the source driver than the second pixel is, and
wherein a pulse width of the second write signal is larger than a pulse width of the first write signal.

2. The display device according to claim 1, further comprising a display controller configured to be supplied with a digital signal comprising a dummy signal,
wherein the pulse width of each of the first write signal and the second write signal is controlled by a length of a period of the dummy signal.

3. The display device according to claim 1, further comprising a display controller configured to be supplied with a digital signal comprising a dummy signal,
wherein the display controller is configured to generate a reference clock signal from the digital signal and supply a clock signal generated from the reference clock signal to the gate driver, and
wherein the clock signal is synchronized with the digital signal.

4. The display device according to claim 1, further comprising a display controller configured to be supplied with a digital signal comprising a dummy signal,
wherein the display controller is configured to generate a reference clock signal from the digital signal and supply a clock signal generated from the reference clock signal to the gate driver, and
wherein a frequency of the clock signal is changed by a length of a period of the dummy signal.

5. The display device according to claim 1, wherein the first row is closer to the source driver than the second row is.

6. The display device according to claim 1,
wherein the first write signal is supplied to the first pixel through a first scan line,
wherein the second write signal is supplied to the second pixel through a second scan line, and
wherein the first scan line is adjacent to the second scan line.

7. The display device according to claim 1,
wherein the first write signal is supplied in a first period,
wherein the second write signal is supplied in a second period, and
wherein the first period and the second period are sequentially provided.

8. The display device according to claim 1, wherein each of the first pixel and the second pixel comprises a liquid crystal element.

9. The display device according to claim 1, wherein each of the first pixel and the second pixel comprises a light-emitting element.

10. An electronic device comprising the display device according to claim 1.

11. A display method for a display device, the display device comprising:
a source driver;
a first pixel in a first row and a second pixel in a second row; and
a gate driver,
wherein the first pixel is closer to the source driver than the second pixel is,
the display method comprising the steps of:
supplying a first write signal to the first pixel from the gate driver; and
supplying a second write signal to the second pixel from the gate driver,
wherein a pulse width of the second write signal is larger than a pulse width of the first write signal.

12. The display method of a display device according to claim 11,
wherein the display device further comprises a display controller configured to be supplied with a digital signal comprising a dummy signal, and
wherein the pulse width of each of the first write signal and the second write signal is controlled by a length of a period of the dummy signal.
